(19) United States
(12) Patent Application Publication
(10) Pub. No.: US 2021/0200558 A1
(43) Pub. Date: Jul. 1, 2021

(54) STATE MANAGEMENT SYSTEM, STATE MANAGEMENT METHOD AND STORAGE MEDIUM FOR STORING STATE MANAGEMENT PROGRAM

(71) Applicant: NEC Corporation

(72) Inventors: ATSUSHI KITANO, Tokyo (JP); TAKAYUKI KURODA, Tokyo (JP); MANABU NAKANOYA, Tokyo (JP)

(73) Assignee: NEC Corporation, Minato-ku, Tokyo (JP)

(21) Appl. No.: 16/080,337

(22) PCT Filed: Feb. 27, 2017
(86) PCT No.: PCT/JP2017/007435

§ 371 Date: Aug. 28, 2018

(30) Foreign Application Priority Data
Mar. 3, 2016 (JP) 2016-040767

(51) Int. Cl. G06F 9/445

(52) U.S. Cl. CPC G06F 9/44505

(57) ABSTRACT

A state management system according to an aspect of the present invention includes: a generation unit that generates a state element representing a modification request to change a first state element to a second state element, the first state element representing a state of an element, in which a first setting value is set, of a system of before modification, the second state element representing a state of the element, in which a second setting value is set, of the system of after modification, wherein a current state indicated by the first state element is a current state indicated by the second state element, and the modification request indicates that the current state is a request state, a state that depends on difference between the first setting value and the second setting value is the current state, and the second setting value is a setting value after modification.

### TECHNICAL FIELD

The present invention relates to a state management system, a state management method and a storage medium for storing a state management program.

### BACKGROUND ART

When a system is to be modified, a system administrator creates a document for modification procedure for changing states of parts included in a system to request states. A modification operator conducts a modification operation in accordance with the created document for modification procedure. The system is modified when the modification operation is conducted.

Each modification operation is required to be conducted in a correct order so as to complete all the modification operations. The correct order of modification operations depends on the characteristics of parts included in a system and a combination of the parts. When creating a document for modification procedure, the administrator is required to have a variety of knowledge related to a modification target system and parts included in the system. Thus, creation of a document for modification procedure requires highly specialized expertise and a lot of time.

A requirement for modifying the states of parts as described above can be formally expressed, for example, by state elements and a dependency relationship existing between the state elements.

A state element is information representing a part included in a system. The state element indicates information pertaining a state of a part and a method of modifying the state of the part. A state element includes, for example, identification (id) of the state element, an attribute value of the state element, states that the state element may take, a state transition to be performed between states, a current state, and a request state.

FIG. 25 is an explanatory view illustrating an example of the state element. In the drawings appended hereto, a state element is represented by a rounded rectangle as illustrating in FIG. 25.

In a diagram of a state element, a text inside a rectangle on the upper left of the rounded rectangle represents id of the state element. The id of the state element illustrated in FIG. 25 is “e”.

Further, in a diagram of a state element, a text inside a rectangle on the upper right of the rounded rectangle represents a setting value that is set in the state element. The setting value that is set in the state element “e” illustrated in FIG. 25 is “P”.

Furthermore, in a diagram of a state element, an ellipse inside the rounded rectangle represents a state that the state element may take and a text inside the ellipse represents the name of the state. The state element “e” illustrated in FIG. 25 may take any one state of a state “s₁”, a state “s₂” and a state “s₃”.

Further, in a diagram of a state element, a double-line ellipse represents a current state, and a black ellipse represents a request state. In the state element “e” illustrated in FIG. 25, the state “s₁” is a current state and the state “s₂” is a request state. The state “s₃” is the same state as the state “s₁” except for the setting value. A setting value is set in the state “s₃” and is different from the setting value “P” that is set in the state “s₁”.

In a diagram of a state element, an arrow that connects ellipses represents a state transition. A state transition “t₁”, a state transition “t₂”, a state transition “t₃”, a state transition “t₄” and a state transition “r₁” are executed between states of the state element “e” illustrated in FIG. 25.

The state transitions “t₁” to “t₄” are state transitions that achieve a modification request for the system. In a diagram of a state element, a state transition that achieves a modification request is represented by a solid arrow.

The state transition “r₁” is a state transition that redefines a current state. In a diagram of a state transition, a state transition that redefines a current state is represented by a double-line arrow.

The state element illustrated in FIG. 25 represents a modification request that sets the setting value of the part “e” to “P” and changes the state of the part “e” from the state “s₁” to the state “s₂”. FIG. 25 indicates that the transition from the state “s₁” to the state “s₂” corresponds to the state transition “t₁”. That is, a modification procedure generation system that generates a modification procedure, on the basis of a state element, can derive a modification procedure “t₁” on the basis of the information illustrated in FIG. 25.

When the modification procedure generation system uses a plurality of state elements as the one illustrated in FIG. 25, definition of a dependency relationship between the plurality of state elements allows the modification procedure generation system to derive a correct modification procedure.

FIG. 26 is an explanatory view illustrating another example of a state element. In the example illustrated in FIG. 26, a modification request for a system is represented by the plurality of state elements. The activation order of the elements of the system is derived on the basis of the plurality of state elements illustrated in FIG. 26.

FIG. 26 illustrates a state element “VM” and a state element “MW”. The state element “VM” represents a virtual machine (VM; hereinafter referred to as the “VM”). The state element “MW” represents middleware (MW; hereinafter, referred to as the “MW”) that is loaded in the virtual machine represented by the state element “VM”. As illustrated in FIG. 26, the setting values of the modification requests for the state element “VM” and the state element “MW” are “P”.

As illustrated in FIG. 26, the state element “VM” and the state element “MW” may take any one state of a state “F”, a state “T”, and a state “U”. The state “F” means a stop state. The state “T” means an operating state.

The state “U” means a state that is an operating state and in which a setting value of a modification request is not set in the state element. The state “U” of the state element in the example illustrated in FIG. 26 represents a state of operating in a condition where a value that is different from the setting value “P” is set in the state element. As illustrated in FIG. 26, in the state element “VM” and the state element “MW”, the current states are both the state “F” and the request states are both the state “T”.

As illustrated in FIG. 26, a transition from the state “F” to the state “T” in the state element “VM” is a state transition “start”. That is, the state transition “start” corresponds to an activation operation of the VM. Likewise, each of a transition from the state “T” to the state “F” and a transition from the state “U” to the state “F” in the state element “VM” corresponds to a state transition “stop”. That is, the state transition “stop” corresponds to a stop operation of the VM.

A transition from the state “U” to the state “T” in the state element “VM” is a state transition “reload”. That is, the state transition “reload” corresponds to a reading operation of a setting value. The transition from the state “T” to the state “U” is a state transition that redefines the current state based on a setting value.

Likewise, as illustrated in FIG. 26, a transition from the state “F” to the state “T” in the state element “MW” is a state transition “start”. That is, the state transition “start” corresponds to a start of provision of services by the MW. A transition from the state “T” to the state “F” in the state element “MW” corresponds to a state transition “stop”. That is, the state transition “stop” corresponds to a stop of provision of services by the MW.

As described above, the MW is implemented in the VM. That is, the VM is required to be in an activated state for the MW to start or stop providing services. A procedure of executing a state transition of the MW when the VM is in a stop state is an erroneous procedure.

Constraints on such a system modification as described above are defined in FIG. 26. In a diagram of a state elements, an arrow of a broken line represents a constraint and a white circle represents a state transition to which the constraint is applied.

FIG. 26 illustrates a defined constraint directed from the state transition “start” of the state element “MW” to the state “T” of the state element “VM”. That is, FIG. 26 illustrates that the state transition from the state “F” to the state “T” in the state element “MW” is executed under the constraint that the state element “VM” is the state “T”.

FIG. 26 also illustrates a constraint directed from the state transition “stop” of the state element “MW” to the state “T” of the state element “VM”. That is, FIG. 26 illustrates that the state transition from the state “T” to the state “F” in the state element “MW” is executed under the constraint that the state element “VM” is the state “T”.

The modification procedure generation system using state elements is capable of deriving an execution procedure of state transitions by which the states of all the state elements are modified from current states to request states while satisfying dependency caused by a constraint. In the example illustrated in FIG. 26, the modification procedure generation system derives a procedure that first causes the state of the state element “VM” to make a transition from the state “F” to the state “T” and then causes the state of the state element “MW” to make a transition from the state “F” to the state “T”.

That is, the modification procedure generation system is capable of deriving a modification procedure by which the MW is activated after the VM is activated. PTL 1 and NPL 1 describe methods of deriving a system modification procedure on the basis of the state elements as described above.

Meanwhile, the state elements illustrated in FIGS. 25 and 26 includes information that is defined in three different stages.

For example, a state that a state element may take, a setting value that can be set in a state element, a state transition that achieves a modification request, and a state transition that redefines a current state of a state element in such a way that the current state meets a modification request are included in information that depends on a characteristic of a state element. That is, the information that depends on the characteristics of a state element is static information that is defined when the state element itself is defined.

A current state and a request state are elements that depend on a condition of a system element represented by a state element. A request state is variable information that is defined by a system administrator or the like. A current state is information that is continually managed even after being modified to a different state by a modification operation.

In other words, each state element usually retains only a current state. The modification request usually specifies only a request state. A state element that represents a modification request is generated on the basis of a state element including a current state and a state element including a request state. The following describes an example of generating a state element representing a modification request.

FIG. 27 is an explanatory view illustrating an example of generating a state element that represents a modification request. The state elements “e” illustrated in FIG. 27 are the same state elements as the state element “e” illustrated in FIG. 25.

The illustrated in (a) of FIG. 27 is the state element that represents a part “e” of before state modification. The current state of the state element “e” illustrated in (a) of FIG. 27 is a state “s₁”. The illustrated in (b) of FIG. 27 is the state element that represents the part “e” of after state modification. The current state of the state element “e” illustrated in (b) of FIG. 27 is a state “s₂”.

The illustrated in (c) of FIG. 27 is the state element that represents a modification request to modify the state. The illustrated in (c) of FIG. 27 represents a modification request to cause the current states of the part of before and after the performance of the modification thereof to be different.

When the state element illustrated in (a) of FIG. 27 and the state element illustrated in (b) of FIG. 27 are compared, the current state of the part “e” is changed from the state “s₁” to the state “s₂”. Thus, as illustrated in (c) of FIG. 27, in the state element that represents the modification request to modify the state, the current state is set to the state “s₁” and the request state is set to the state “s₂”.

The setting value of the state element illustrated in (a) of FIG. 27 and the setting value of the state element illustrated in (b) of FIG. 27 are both “P”. Thus, as illustrated in (c) of FIG. 27, the setting value of the modification request, which is set to the state element that represents the modification request for the state, is “P”. The state element that represents the modification request is derived as described above.

FIG. 28 is an explanatory view illustrating another example of generating a state element that represents a modification request. The generation example illustrated in FIG. 28 is an example of generating a state element that represents a request for changing the state of the VM from a stop state to an activated state. Further, FIG. 28 is an example where specific values are substituted in the generation example illustrated in FIG. 27.

The state elements “VM” illustrated in FIG. 28 are the same state elements as the state element “VM” illustrated in FIG. 26. “VM: vm1” is described inside a rectangle on the upper left of the state element “VM” illustrated in FIG. 28. That is, the state elements illustrated in FIG. 28 are state elements that represent a VM the name of which is vm1.

A description “ip: 192.168.10.1” exists inside a rectangle on the upper right of the state element “VM” illustrated in FIG. 28. The “ip” means an internet protocol (ip) address. That is, an ip address is set as a setting value in the state element “VM” illustrated in FIG. 28.

The illustrated in (a) of FIG. 28 is the state element “VM” of before state modification. As illustrated in (a) of FIG. 28, the ip address is set to “192.168.10.1”. The current state is a state “F”, that is, a stop state.

The illustrated in (b) of FIG. 28 is the state element “VM” of after state modification. As illustrated in (b) of FIG. 28, the ip address is set to “192.168.10.1”. The current state is a state “T”, that is, an operating state.

The illustrated in (c) of FIG. 28 is the state element that represents a modification request to modify a state. When the state element illustrated in (a) of FIG. 28) and the state element illustrated in (b) of FIG. 28 are compared, the state of vm1 of before state modification is the state “F” and the state of vm1 of after state modification is the state “T”. Thus, as illustrated in (c) of FIG. 28, in the state element that represents the modification request to modify the state, the current state is set to the state “F” and the request state is set to the state “T”.

The ip address that is set in the state element illustrated in (a) of FIG. 28 and the ip address that is set in the state element illustrated in (b) of FIG. 28 are both “192.168.10.1”. Thus, as illustrated in (c) of FIG. 28, the ip address of the modification request, which is set in the state element that represents the modification request to modify the state, is “192.168.10.1”.

The state element that represents the modification request is derived as described above.

FIG. 29 is an explanatory view illustrating another example of generating a state element that represents a modification request. The generation example illustrated in FIG. 29 is an example of generating a state element that represents a modification request causing the current states to be the same and only the setting values of before and after state modification to be different. The current state is redefined in the state element that represents the modification request illustrated in FIG. 29. The state elements “e” illustrated in FIG. 29 are the same state elements as the state element “e” illustrated in FIG. 25.

The illustrated in (a) of FIG. 29 is the state element that represents a part “e” of before state modification. The illustrated in (b) of FIG. 29 is the state element that represents the part “e” of after state modification. The current state of the state element “e” illustrated in (a) of FIG. 29 and the current state of the state element “e” illustrated in (b) of FIG. 29 are both the state “s₁”.

The setting value of the state element illustrated in (a) of FIG. 29 is “P”. The setting value of the state element illustrated in (b) of FIG. 29 is “P′” that is different from the setting value of the state element illustrated in (a) of FIG. 29.

The illustrated in (c) of FIG. 29 is the state element that represents a modification request to modify the state. As illustrated in (c) of FIG. 29, in the above-described case, the current state of the state element that represents a modification request to modify the state is redefined as the state “s₃” of which setting value is different from the setting value of the state “s₁”. The request state is set to the state “s₁” and the setting value of the modification request is set to “P′”. The state element that represents the modification request is derived as described above.

FIG. 30 is an explanatory view illustrating another example of generating a state element that represents a modification request. The generation example illustrated in FIG. 30 is an example of generating a state element that represents a modification request to reload the ip address of the VM. Further, FIG. 30 is an example that is the generation example of FIG. 29 with which specific values are provided.

The state elements “VM” illustrated in FIG. 30 are the same state elements as the state element “VM” illustrated in FIG. 26. Further, the state elements illustrated in FIG. 30 are state elements that represent a VM the name of which is vm1. Further, an ip address is set as a setting value in the state element “VM” illustrated in FIG. 30.

The illustrated in (a) of FIG. 30 is the state element “VM” of before state modification. As illustrated in (a) of FIG. 30, the ip address is set to “192.168.10.1”. The current state is the state “T”. That is, (a) of FIG. 30 represents vm1 that operates with the ip address set to “192.168.10.1”.

The illustrated in (b) of FIG. 30 is the state element “VM” of after state modification. As illustrated in (b) of FIG. 30, the ip address is set to “192.168.10.2”. The current state is the state “T”. That is, (b) of FIG. 30 represents vm1 that operates with the ip address set to “192.168.10.2”.

The illustrated in (c) of FIG. 30 is the state element that represents a modification request to modify a state. In consideration of the generation example illustrated in FIG. 29, the current state of the state element that represents the modification request is redefined as the state “U” where a state element is in an operating state and a setting value of the modification request is not set, as illustrated in (c) of FIG. 30.

Further, as illustrated in (c) of FIG. 30, the request state is set to the state “T” that is an operating state. The setting value of the modification request is set to the ip address “192.168.10.2” that is set in the state element of after state modification illustrated in (b) of FIG. 30. The state element that represents the modification request is derived as described above.

As illustrated in FIG. 29 and FIG. 30, a method of redefining a current state when the state elements of before and after modification has the same current states and the state elements has different setting values is known.

### CITATION LIST

### Patent Literature

[PTL 1] Japanese Unexamined Patent Application Publication No. 2015-215887

### Non Patent Literature

[NPL 1] S. Hangen and A. Kemper, “Model-based planning for state-related changes to infrastructure and software as a service instances in large data centers”, 2010 IEEE 3rd International Conference on Cloud Computing (CLOUD), 2010, pp. 11-18.

### SUMMARY OF INVENTION

### Technical Problem

A case where there are a plurality of possible states as which a current state can be redefined when a state element that represents a modification request is derived is considered below.

FIG. 31 is an explanatory view illustrating another example of generating a state element that represents a modification request. The state elements illustrated in FIG. 31 are state elements that represent a VM the name of which is vm1. Further, in the state elements illustrated in FIG. 31, an ip address and a place (hereinafter, referred to as the “host”) where the vm1 operates are set as setting values. The value set to the location illustrated in FIG. 31 represents a host.

The illustrated in (a) of FIG. 31 is the state element “VM” of before state modification. As illustrated in (a) of FIG. 31, the ip address is set to “192.168.10.1” and the location is set to “host1”. The current state is the state “S₁”.

The illustrated in (b) of FIG. 31 is the state element “VM” of after state modification. As illustrated in (b) of FIG. 31, the ip address is set to “192.168.10.1” and the location is set to “host2”. The current state is state “S₁”. That is, the state element illustrated in (a) of FIG. 31 and the state element illustrated in (b) of FIG. 31 are different only in the host.

The illustrated in (c) of FIG. 31 is a state element that represents a modification request to modify a state. The state “U₂” defined in each state element illustrated in (a) of FIG. 31 to (c) of FIG. 31 is a state that is an operating state and in which a setting value in a modification request is not set, which is required to derive migration processing for causing the vm1 to operate in a different host.

That is, when the setting value of the ip address is not modified and only the setting value of the location is modified as illustrated in (a) of FIG. 31 and (b) of FIG. 31, the current state of the state element that represents the modification request is assumed to be redefined as the state “U₂” as illustrated in (c) of FIG. 31. The processing of migrating vm1 to the host that is set is derived by redefining the current state as the state “U₂”.

The state “U₁” that is defined in each of the state elements illustrated in (a) of FIG. 31 to (c) of FIG. 31 is a state that is an operating state and in which a setting value in a modification request is not set, which is required to derive reload processing of the ip address of the vm1.

That is, when the setting value of the location is not modified and only the setting value of the ip address is modified, the current state of the state element that represents the modification request is assumed to be redefined as the state “U₁”. The processing of reloading the ip address of the vm1 is derived by redefining the current state as the state “U1”.

As described above, the example illustrated in FIG. 31 is an example in which a target state as which a current state is redefined depends on difference between a setting value of before modification and a setting value of after modification. However, neither PTL 1 nor NPL 1 describe a method capable of selecting a target state, as which a current state is redefined, on the basis of difference between a setting value of before modification and a setting value of after modification. In the case of the example illustrated in FIG. 31, an existing means of redefining a current state is not able to determine whether to redefine the current state as the state “U1” or as the state “U2”.

An objective of the present invention is, therefore, to provide a state management system, a state management method, and a state management program that can determine a target state of redefinition of a current state in a state element that represents a modification request.

### Solution to Problem

A state management system according to an aspect of the present invention includes: generation means for generating a state element that represents a modification request to change a first state element to a second state element based on the first state element and the second state element, the first state element representing a state of an element, in which a first setting value is set, of a system of before modification, the second state element representing a state of the element, in which a second setting value is set, of the system of after modification, wherein a current state indicated by the first state element is a current state indicated by the second state element, and the generation means generates the state element representing the modification request indicating that the current state is a request state, a state that depends on difference between the first setting value and the second setting value is the current state, and the second setting value is a setting value after modification.

A state management method according to an aspect of the present invention includes: generating a state element that represents a modification request to change a first state element to a second state element based on the first state element and the second element, the first element representing a state of an element, in which a first setting value is set, of a system of before modification, the second state element representing a state of the element, in which a second setting value is set, of the system of after modification, wherein, a current state indicated by the first state element is a current state indicated by the second state element, and the generating the state element includes generating the state element representing the modification request indicating that the current state is a request state, a state that depends on difference between the first setting value and the second setting value is the current state, and the second setting value is a setting value after modification.

A storage medium according to an aspect of the present invention stores a state management program causing a computer to execute: generation processing of generating a state element that represents a modification request to change a first state element to a second state element based on the first state element and the second state element, the first state element representing a state of an element, in which a first setting value is set, of a system of before modification, the second state element representing a state of the element, in which a second setting value is set, of the system after modification, wherein a current state indicated by the first state element is a current state indicated by the second state element, and the generation processing generates the state element representing the modification request indicating that the current state is a request state, a state that depends on difference between the first setting value and the second setting value is the current state, and the second setting value is a setting value after modification. An aspect of the present invention can be achieved by a program stored in the storage medium.

### Advantageous Effects of Invention

According to the present invention, a target state of redefining a current state in a state element that represents a modification request can be determined.

### BRIEF DESCRIPTION OF DRAWINGS

FIG. 1 is a block view illustrating a configuration example of a state management system 100 according to a first example embodiment of the present invention.

FIG. 2 is an explanatory view illustrating an example of a state element type according to the present example embodiment.

FIG. 3 is an explanatory view illustrating an example of a state element type that is described in a text format.

FIG. 4 is an explanatory view illustrating an example of a state element according to the present example embodiment.

FIG. 5 is an explanatory view illustrating an example of a state element that is described in a text format.

FIG. 6 is an explanatory view illustrating another example of a state element according to the present example embodiment.

FIG. 7 is an explanatory view illustrating another example of a state element that is described in a text format.

FIG. 8 is an explanatory view illustrating another example of a state element type of the present example embodiment.

FIG. 9 is an explanatory view illustrating another example of a state element type that is described in a text format.

FIG. 10 is an explanatory view illustrating another example of a state element of the present example embodiment.

FIG. 11 is an explanatory view illustrating another example of a state element that is described in a text format.

FIG. 12 is an explanatory view illustrating another example of a state element of the present example embodiment.

FIG. 13 is an explanatory view illustrating another example of a state element that is described in a text format.

FIG. 14 is an explanatory view illustrating another example of a state element of the present example embodiment.

FIG. 15 is an explanatory view illustrating another example of a state element that is described in a text format.

FIG. 16 is an explanatory view illustrating another example of a state element of the present example embodiment.

FIG. 17 is an explanatory view illustrating another example of a state element that is described in a text format.

FIG. 18 is an explanatory view illustrating another example of a state element of the present example embodiment.

FIG. 19 is an explanatory view illustrating another example of a state element that is described in a text format.

FIG. 20 is an explanatory view illustrating another example of a state element of the present example embodiment.

FIG. 21 is an explanatory view illustrating another example of a state element that is described in a text format.

FIG. 22 is a flowchart illustrating operation of generation processing by the state management system 100 according to the present example embodiment.

FIG. 23 is a flowchart illustrating operation of state comparison processing by a state comparative calculation unit 120.

FIG. 24 is a block view illustrating a configuration of a state management system according to a second embodiment of the present invention.

FIG. 25 is an explanatory view illustrating an example of a state element.

FIG. 26 is an explanatory view illustrating another example of a state element.

FIG. 27 is an explanatory view illustrating an example of generating a state element that represents a modification request.

FIG. 28 is an explanatory view illustrating another example of generating a state element that represents a modification request.

FIG. 29 is an explanatory view illustrating another example of generating a state element that represents a modification request.

FIG. 30 is an explanatory view illustrating another example of generating a state element that represents a modification request.

FIG. 31 is an explanatory view illustrating another example of generating a state element that represents a modification request.

FIG. 32 is a diagram illustrating a hardware configuration of a computer that achieves units of the state management systems according to the example embodiments of the present invention.

### DESCRIPTION OF EMBODIMENTS

### First Example Embodiment

[Description of Configuration]

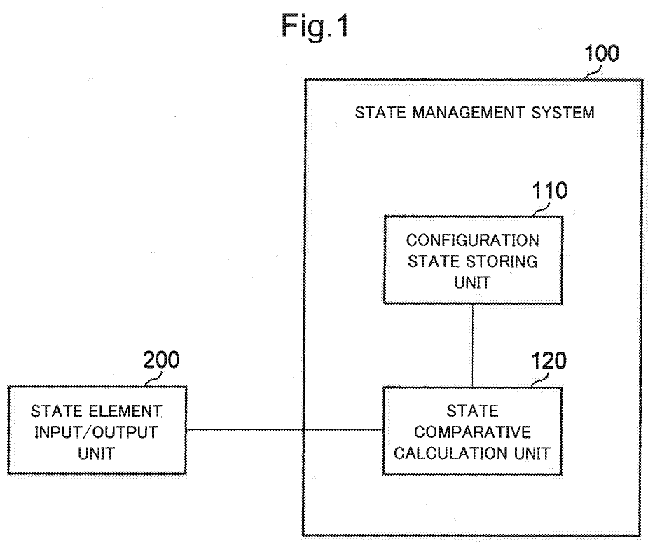

An example embodiment of the present invention is described in the following with reference to the drawings. FIG. 1 is a block view illustrating a configuration example of a state management system 100 according to a first example embodiment of the present invention. As illustrated in FIG. 1, the state management system 100 of the present example embodiment includes a configuration state storing unit 110 and a state comparative calculation unit 120. The state management system 100 of the present example embodiment is communicably connected to an external state element input/output unit 200.

The configuration state storing unit 110 has a function of storing a state element that represents a current state of a part included in a system of before state modification. The configuration state storing unit 110 may store a different kind of state element, and the like.

The state comparative calculation unit 120 has a function of generating a state element that represents a modification request. The state comparative calculation unit 120 is communicably connected with the state element input/output unit 200 via a communication network or the like. The state comparative calculation unit 120 generates a state element that represents a modification request by comparing a state element obtained from the configuration state storing unit 110 and a state element received from the state element input/output unit 200.

The state element input/output unit 200 has a function of inputting/outputting a state element. The state element input/output unit 200 receives a state element that represents a current state of a part included in a system of after state modification, which is defined by a user or by a different device, from the user or different device. The state element input/output unit 200 also receives a state element that represents a modification request generated by the state management system 100.

The state management system 100 of the present example embodiment compares a state element that represents a part included in a system of before state modification and a state element that represents the part included in the system of after state modification, and redefines the current state of before state modification on the basis of a modified setting value. The state management system 100 generates a state element that represents a modification request including the redefined current state.

The state element that represents a part, according to the present example embodiment, includes reinterpretation conditions in addition to states that the part may take, a state transition that is executed between the states of the part, a setting value of the part, and an id of the part.

The state element that represents a current state of a part retains the current state of the part and a setting value for the current state of the part. Further, the state element that represents a modification request to modify a part includes a current state of the part, a request state of the part, and a setting value in the request state of the part.

In the present example embodiment, the state transition that is executed between states of a part includes the above-described state transition that achieves a modification request of a system. The state transition further includes a state transition that redefines the current state that is caused by reinterpretation of the current state of before state modification, based on a comparison result between a state element that represents a part included in a system of before state modification and a state element that represents the part included in the system of after state modification.

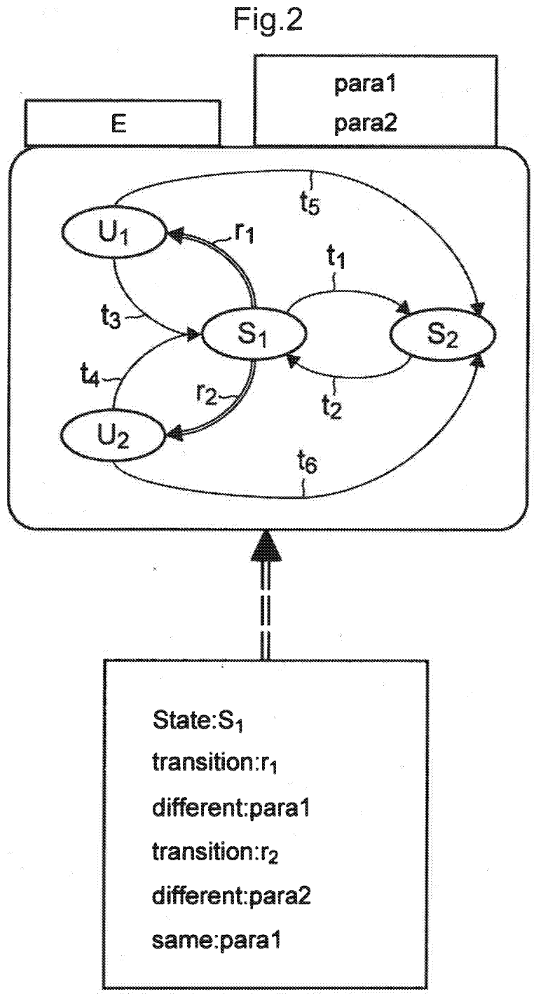

FIG. 2 is an explanatory view illustrating an example of a state element type of the present example embodiment. The state element type indicates static information of a part based on the characteristics of the part. Further, the state element of the present example embodiment includes a plurality of states, modification methods of the states, and a plurality of setting values.

The state element type illustrated in FIG. 2 includes static information based on the characteristics of the part. As illustrated in FIG. 2, the state element type is represented by a rounded rectangle.

Further, a text inside a rectangle on the upper left of the rounded rectangle represents an id of the state element type, that is, an id of the part. The id of the state element type illustrated in FIG. 2 is “E”.

Further, a text inside a rectangle on the upper right of the rounded rectangle represents the name of a setting value of the part. FIG. 2 illustrates there are two setting values, “para1” and “para2”, as the setting values that are set in the part “E”.

Further, an ellipse inside the rounded rectangle represents a state that the part may take and a text inside the ellipse represents the name of the state.

The part “E” illustrated in FIG. 2 may take any one state of a state “S₁”, a state “S₂”, a state “U₁” and a state “U₂”. The state “U₁” and the state “U₂” are states reinterpreted from the state “S₁”.

An arrow that connects ellipses represents a state transition. The state transitions illustrated in FIG. 2 include a state transition “t₁” from the state “S₁” to the state “S₂”, a state transition “t₂” from the state “S₂” to the state “s₁”, a state transition “t₃” from the state “U₁” to the state “S₁”, a state transition “t₄” from the state “U₂” to the state “S₁”, a state transition “t₅” from the state “U₁” to the state “S₂”, and a state transition “t₆” from the state “U₂” to the state “S₂”. The state transitions further include a state transition “r₁” from the state “S₁” to the state “U₁”, and a state transition “r₂” from the state “S₁” to the state “U₂”.

The state transition executed between states includes a state transition that achieves a modification request to perform modification from a current state to a request state, and a state transition that redefines a current state on the basis of a comparison result between a state before state modification and a state after state modification.

A solid arrow included in arrows connecting ellipses represents a state transition that achieves a modification request for a system. That is, the state transitions “t₁” to “t₆” illustrated in FIG. 2 represent state transitions that achieves modification requests for the system.

A double-line arrow connecting ellipses represents a state transition that redefines a current state caused by reinterpretation of a current state of a part included in a system of before state modification. That is, the state transitions “r₁” and “r₂” illustrated in FIG. 2 represent state transitions that are caused by reinterpretation of a current state of a part included in the system of before state modification.

A text inside a rectangle that is connected by an arrow of a broken line with the rounded rectangle indicates conditions of generating a state element that represents a modification request based on a comparison result.

The conditions of generating a state element that represents a modification request, illustrated in FIG. 2, indicate that, when the current state of before modification and the current state of after modification are commonly the state “S₁” and the setting value “para1” is modified, the state transition “r₁” is executed by reinterpretation. They also indicate that, when the current state of before modification and the current state of after modification are commonly the state “S₁” and the setting value “para2” is modified, the state transition “r₂” is executed by reinterpretation.

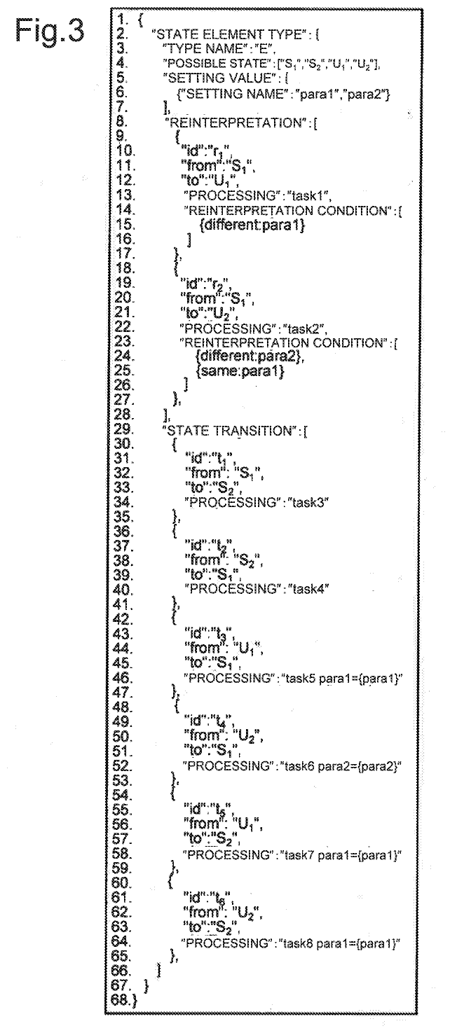

FIG. 3 illustrates an example of a text-format description of the state element type that includes static information based on the characteristics of the part illustrated in FIG. 2. FIG. 3 is an explanatory view illustrating an example of the state element type that is described in a text format. The text format illustrated in FIG. 3 is a JavaScript (registered trademark) Object Notation (JSON) format. The numbers presented on the left end in FIG. 3 is row numbers, which are the same in other diagrams.

The item of “state element type” illustrated in FIG. 3 indicates that text data illustrated in FIG. 3 are text data describing a state element type that includes static information.

The item of “type name” illustrated in FIG. 3 indicates the name of a part represented by the state element type illustrated in FIG. 3. The item of “possible state” illustrated in FIG. 3 includes a state that the state element type illustrated in FIG. 3 may take.

The item of “setting value” illustrated in FIG. 3 represents a setting value that is set in the state element type illustrated in FIG. 3. The item of “setting name” illustrated in FIG. 3 includes a name of a setting value that is set in the state element type illustrated in FIG. 3.

The item of “reinterpretation” illustrated in FIG. 3 represents a state transition that occurs when a current state of the part included in the system of before state modification is reinterpreted.

The item of “id” inside the item of “reinterpretation” illustrated in FIG. 3 indicates an identifier of a state transition that is caused by reinterpretation. Further, the item of “from” indicates a current state of the part of before reinterpretation. The item of “to” indicates a current state of the part of after reinterpretation. The item of “processing” indicates processing that is executed when the state transition is made.

Further, the item of “reinterpretation condition” inside the item of “reinterpretation” illustrated in FIG. 3 represents a condition under which reinterpretation is executed. Values that are defined, for example, in the “setting name” are set as the values of the items of “different” and “same” inside the item of “reinterpretation condition”.

The item of “different” is an item set as follows. The value to which the item of “different” is set indicates a setting value representing a condition that reinterpretation is executed when the setting value indicated by the value is modified. The item of “same” is an item set as follows. The value to which the item of “same” is set indicates a setting value representing a condition that reinterpretation is executed when the setting value indicated by the value is not modified.

The reinterpretation condition may be represented by the items of “different” and “same” that are both defined therein. When both of the items are defined, reinterpretation is executed only when conditions represented by both of the items are satisfied.

The content of lines 9 to 17 in FIG. 3 indicates the following content pertaining to the state transition “r₁” that is caused by reinterpretation. That is, the state transition “r₁” is a state transition in which, when both of current states of before and after state modification are the state “S₁” and the setting value “para1” is modified, the processing of “task1” is executed, thereby causing the current state to make a transition from the state “S₁” to the state “U₁”.

Similarly, the content of lines 18 to 27 in FIG. 3 indicates the following content pertaining to the state transition “r₂” that is caused by reinterpretation. That is, the state transition “r₂” is a state transition in which, when both of current states of before and after state modification are the state “S₁”, the setting value “para1” is not modified and the setting value “para2” is modified, the processing of “task2” is executed, thereby causing the current state to make a transition from the state “S₁” to the state “U₂”.

The item of “state transition” illustrated in FIG. 3 represents a state transition that achieves a modification request for the system. The item of “id” inside the item of “state transition” represents an identifier of the state transition that achieves the modification request for the system. The item of “from” represents a base of the state transition of the part. The item of “to” represents a target of the state transition of the part.

The item of “processing” inside the item of “state transition” illustrated in FIG. 3 represents processing that is executed when the state transition is made. In the item of “processing”, information that is required for executing the processing is described. As the information that is required for executing the processing, for example, a state of the part, or a state of the part and a setting value are described.

The content of lines 30 to 41 in FIG. 3 indicates that the state transition “t₁” is a state transition in which the processing “task3” is executed, thereby causing the state to make a transition from the state “S₁” to the state “S₂”. In addition, this content indicates that the state transition “t₂” is a state transition in which the processing “task4” is executed, thereby causing the state to make a transition from the state “S₂” to the state “S₁”.

The content of lines 42 to 47 in FIG. 3 indicates that the state transition “t₃” is a state transition in which a setting value acquired from information representing the current state is substituted for the setting value “para1”, and the processing “task5” is executed, thereby causing the state to make a transition from the state “U₁” to the state “S₁”.

The content of lines 48 to 53 in FIG. 3 indicates that the state transition “t₄” is a state transition in which a setting value acquired from information representing the current state is substituted for the setting value “para2”, and the processing “task6” is executed, thereby causing the state to make a transition from the state “U₂” to the state “S₁”.

The content of lines 54 to 59 in FIG. 3 indicates that the state transition “t₅” is a state transition in which a setting value acquired from information representing the current state is substituted for the setting value “para1”, and the processing “task7” is executed, thereby causing the state to make a transition from the state “U₁” to the state “S₂”.

The content of lines 60 to 65 in FIG. 3 indicates that the state transition “t₆” is a state transition in which a setting value acquired from information representing the current state is substituted for the setting value “para2”, and the processing “task8” is executed, thereby causing the state to make a transition from the state “U₂” to the state “S₂”.

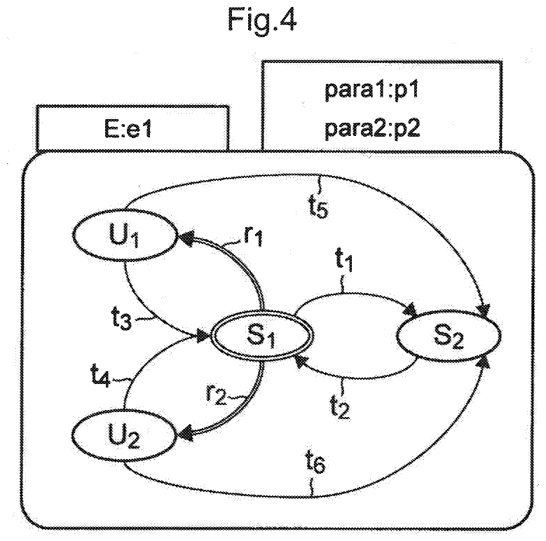

FIG. 4 is an explanatory view illustrating an example of the state element of the present example embodiment. The state element illustrated in FIG. 4 is a state element that represents a current state of a part and is based on the static information included in the state element type illustrated in FIG. 2.

The id of the state element illustrated in FIG. 4 is “E: e1”. That is, the state element illustrated in FIG. 4 represents a part “E” the part name of which is “e1”. Further, the setting value “para1” of the state element illustrated in FIG. 4 is set to “p1” and the setting value “para2” is set to “p2”

A double-line ellipse represents a current state. The current state of the state element illustrated in FIG. 4 is the state “S₁”.

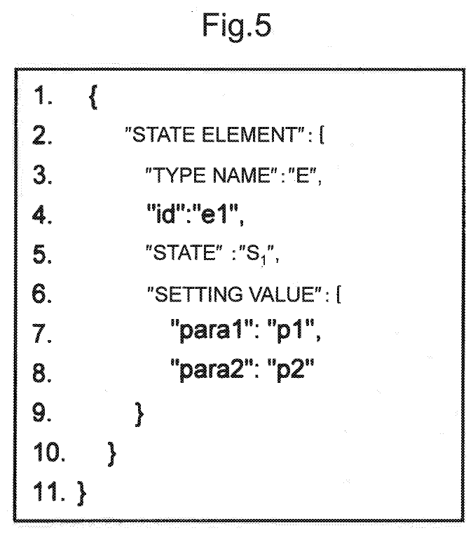

The illustrated in FIG. 5 is an example of a text-format description of the state element that represents the current state of the part, is based on static information included in the state element type and is illustrated in FIG. 4. FIG. 5 is an explanatory view illustrating an example of the state element that is described in a text format. The text format illustrated in FIG. 5 is a JSON format.

The item of “state element” illustrated in FIG. 5 indicates that the text data illustrated in FIG. 5 are text data describing a state element that represents a current state of a part and that is based on static information.

The item of “type name” illustrated in FIG. 5 represents the name of the part represented by the state element type illustrated in FIG. 5. The item of “id” illustrated in FIG. 5 represents an identifier of the state element that represents the current state of the part and that is defined based on the information illustrated in FIG. 5.

The item of “state” illustrated in FIG. 5 represents the current state of the state element that is defined based on the information illustrated in FIG. 5. The item of “setting value” illustrated in FIG. 5 represents a setting value of the state element in the current state illustrated in FIG. 5.

FIG. 5 illustrates that the current state of the part “E” managed by using the identifier “e1” is the state “S₁”, the value of the setting value “para1” is “p1”, and the value of the setting value “para2” is “p2”.

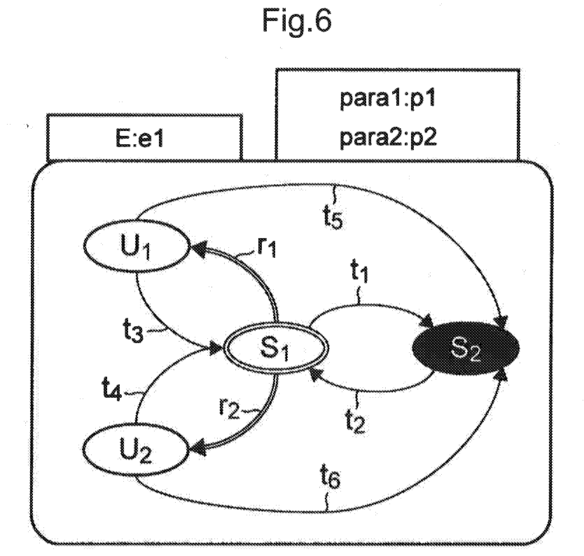

FIG. 6 is an explanatory view illustrating another example of the state element of the present example embodiment. The state element illustrated in FIG. 6 is a state element that represents a modification request to modify a part and that is based on the static information included in the state element type illustrated in FIG. 2.

The id of the state element illustrated in FIG. 6 is the same as the id of the state element illustrated in FIG. 4. The setting values of the state element illustrated in FIG. 6 are the same as the setting values of the state element illustrated in FIG. 4.

A double-line ellipse represents a current state, and a black ellipse represents a request state. The current state of the state element illustrated in FIG. 6 is the state “S₁”, and the request state is the state “S₂”.

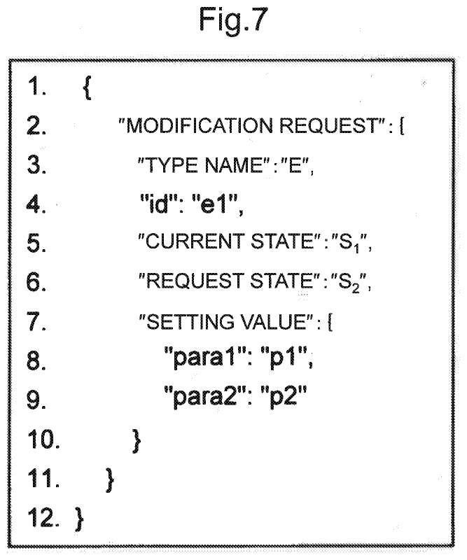

The illustrated in FIG. 7 is an example of a text-format description of the state element that represents a modification request to modify a part and that is based on the static information included in the state element type illustrated in FIG. 6. FIG. 7 is an explanatory view illustrating another example of the state element that is described in a text format. The text format illustrated in FIG. 7 is a JSON format.

The item of “modification request” illustrated in FIG. 7 indicates that the text data illustrated in FIG. 7 are text data that describe a state element representing a modification request to modify a part and based on static information.

The item of “type name” illustrated in FIG. 7 represents the name of the part represented by the state element illustrated in FIG. 7. The item of “id” illustrated in FIG. 7 represents an identifier of the state element that represents the modification request to modify the part and that is defined based on the information illustrated in FIG. 7.

The item of “current state” illustrated in FIG. 7 represents a current state of the part of before state modification. The item of “request state” illustrates a current state of the part of after state modification.

That is, the modification request represented by the state element illustrated in FIG. 7 corresponds to a request to cause the state of the part to make a transition from the “current state” to the “request state”. The item of “setting value” illustrated in FIG. 7 represents a setting value of the state element in the request state illustrated in FIG. 7.

The modification request represented by the state element illustrated in FIG. 7 requires to cause the current state of the part “E” managed by using the identifier “e1” to make a transition from the state “S₁” to the state “S₂”, and, after the transition, to set the value of the setting value “para1” to “p1” and to set the value of the setting value “para2” to “p2”.

The following describes processing of deriving, in consideration of a setting value, a state element that represents a modification request that requires a migration operation that exchanges a host where the VM operates, and a state element that represents a modification request that requires a reload operation that changes the ip address of the VM without exchanging the host.

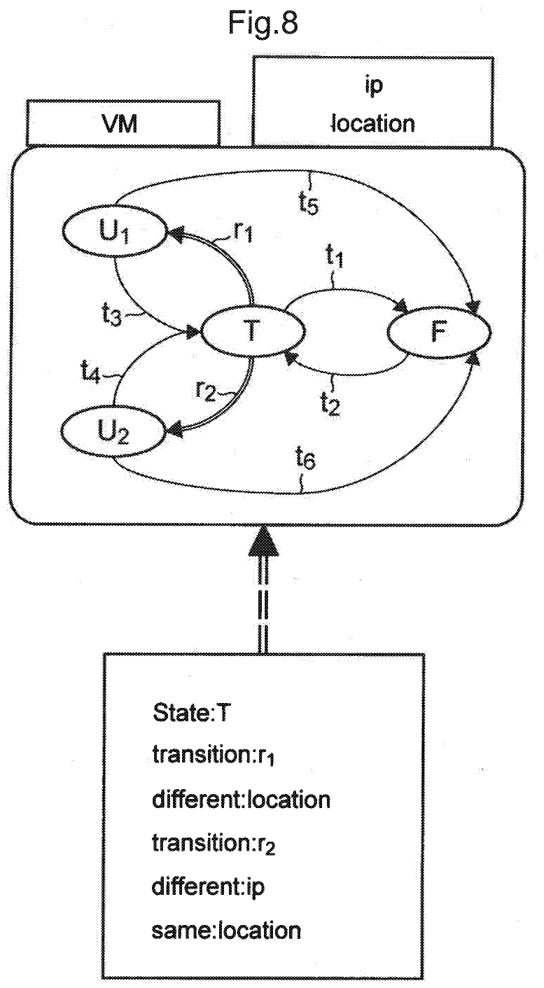

FIG. 8 is an explanatory view illustrating another example of the state element type of the present example embodiment. The state element type illustrated in FIG. 8 includes static information based on the characteristics of the VM. As illustrated in FIG. 8, the state element type is represented by a rounded rectangle in the same way as FIG. 2. In FIG. 8, a content in a rectangle that is connected by a double-line arrow to the rounded rectangle as described above illustrates conditions of generating the state element that represents a modification request.

An “ip” inside a rectangle on the upper right of the rounded rectangle illustrated in FIG. 8 represents the ip address set for the VM. The “location” inside a rectangle on the upper right represents a host where the VM operates.

As illustrated in FIG. 8, the part “VM” may take any one state of a state “T”, a state “F”, a state “U₁” and a state “U₂”. The state “F” means a stop state of the VM. The state “T” means an operating state of the VM.

The conditions of generating a state element that represents a modification request illustrated in FIG. 8 indicate that the state “U₁” is a state as which a current state is redefined in a case where current states, of the VM, of before and after modification of the system are commonly the state “T” and the setting value “location” is modified, the state “U₁”.

In addition, the conditions of generating a state element that represents a modification request illustrated in FIG. 8 indicate that the state “U₂” is a state as which the current state is redefined in a case where current states, of the VM, of before and after modification of the system are commonly the state “T” and the setting value “location” is not modified and the setting value “ip” is modified.

FIG. 8 illustrates a state transition “t₁” from the state “T” to the state “F”, a state transition “t₂” from the state “F” to the state “T”, a state transition “t₃” from the state “U₁” to the state “T”, a state transition “t₄” from the state “U₂” to the state “T”, a state transition “t₅” from the state “U₁” to the state “F”, and a state transition “t₆” from the state “U₂” to the state “F”. The state transitions “t₁” to “t₆” represent state transitions that achieves modification requests for the system.

FIG. 8 further illustrates a state transition “r₁” from the state “T” to the state “U₁” and a state transition “r₂” from the state “T” to the state “U₂”. The state transitions “r₁” and “r₂” represent state transitions that are caused by reinterpretation of a current state, which is of a part included in the system, of before state modification.

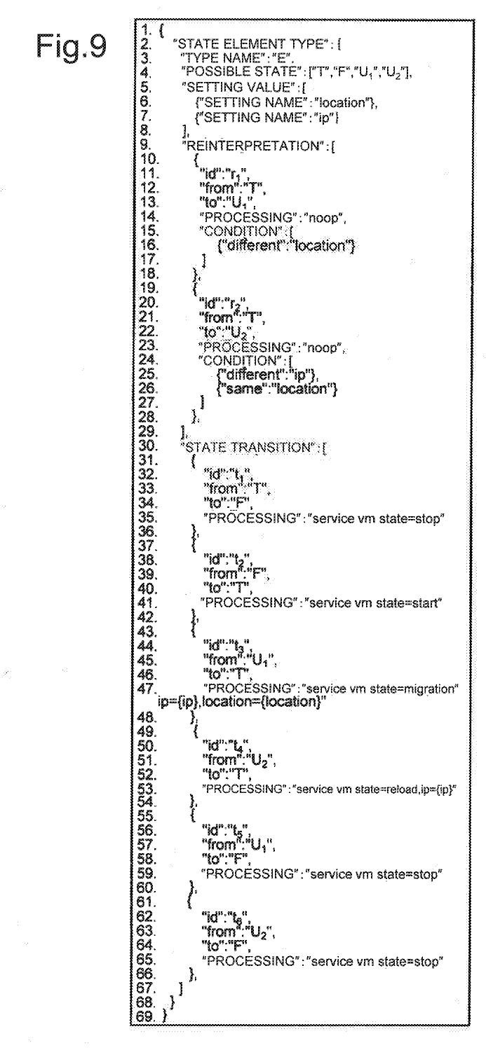

The illustrated in FIG. 9 is an example of a text-format description of the state element type, illustrated in FIG. 8, including static information based on the characteristics of the VM. FIG. 9 is an explanatory view illustrating another example of the state element type that is described in a text format. The text format illustrated in FIG. 9 is a JSON format.

The following describes a configuration content indicated in FIG. 9. The migration operation of the VM is executed by specifying, for example, a host of a migration destination and issuing a migration command.

In this example, reinterpretation that a modification request requests to execute migration processing is performed in a case where the current states of before and after state modification are commonly “in operation” and the setting value “location” varies in the values of before and after state modification. The reinterpretation that execution of the migration processing is requested is performed regardless of whether the setting value “ip” is modified or not.

In the above-described case, the state comparative calculation unit 120 redefines the current state of the part included in the system of before state modification as the state “U₁”. In the processing of redefinition, the state comparative calculation unit 120 does not perform processing for the VM. Thus, as illustrated in FIG. 9, the item of “processing” of the state transition “r₁” that is caused by reinterpretation of the current state is set to a value “noop” that is defined as a value indicating that processing is not executed.

A reload operation of reloading a setting value of a VM is executed by modifying the setting value of the VM in operation and issuing a reload execution command.

In this example, reinterpretation that a modification request requests to execute reload processing is performed in a case where current states of before and after state modification are commonly “in operation” and the setting value “ip” varies in the values of before and after state modification.

In the above-described case, the state comparative calculation unit 120 redefines a current state of a part that is included in a system before state modification as the state “U₂”. In the redefinition processing, the state comparative calculation unit 120 does not perform processing for the VM. Thus, as illustrated in FIG. 9, the item of “processing” of the state transition “r₂” that is caused by reinterpretation of the current state is set to a value “noop” that is defined as a value indicating that processing is not executed.

The state transition “t₁” is a state transition in which the state of the VM makes a transition from an operating state to a stop state. The processing device that executes the state transition “t₁” executes the stop processing to the VM. Thus, the item of “processing” of the state transition “t₁” on line 35 in FIG. 9 is set to a value including “service vm” that means execution of processing for the VM and “state=stop” that means processing of stopping the VM.

The state transition “t₂” is a state transition in which the state of the VM makes a transition from the stop state to the operating state. The processing device that executes the state transition “t₂” performs activation processing to the VM. Thus, the item of “processing” of the state transition “t₂” on line 41 in FIG. 9 is set to a value including “service vm” that means execution of processing to the VM and “state=start” that means processing of activating the VM.

The state transition “t₃” is a state transition in which the state of the VM makes a transition from a state in which the VM is operating in a host that is not indicated by a setting value to a state in which the VM is operating in a host indicated by the setting value. The processing device that executes the state transition “t₃” executes migration processing to the VM.

Thus, the item of “processing” of the state transition “t₃” on line 47 in FIG. 9 is set to a value including “service vm” that means execution of processing for the VM. The item of “processing” is set to the value further including “state=migaration,ip={ip},location={location}” that means migration processing of causing the VM to operate in “location” indicated by the setting value and setting the ip address to “ip”.

The state transition “t₄” is a state transition in which the state of the VM makes a transition from a state in which an ip address that is different from the ip address indicated by a setting value is set in the VM and the VM is operating in a host indicated by a setting value to a state in which the ip address indicated by the setting value is set in the VM and the VM is operating in the same host. The processing device that executes the state transition “t₄” changes the ip address that is set in the VM and executes reload processing of reading the setting value.

Thus, the item of “processing” of the state transition “t₄” on line 53 in FIG. 9 is set to a value including “service vm” that means execution of processing to the VM. The item of “processing” is set to the value further including “state=reload,ip={ip}” that means reload processing of changing the ip address to “ip” and reading the setting value without exchanging the host in which the VM operates.

The state transition “t₅” is a state transition in which the state of the VM makes a transition from a state where the VM is operating in a host that is different from the host indicated by a setting value to a stop state. The processing device that executes the state transition “t₅” executes stop processing to the VM. Thus, the item of “processing” of the state transition “t₅” on line 59 in FIG. 9 is set to a value “service vm” that means execution of processing to the VM and a value “state=stop” that means processing of stopping the VM.

The state transition “t₆” is a state transition in which the state of the VM makes a transition from a state in which an ip address that is different from the ip address indicated by a setting value is set in the VM and the VM is operating in a host indicated by a setting value to a stop state. The processing device that executes the state transition “t6” executes stop processing to the VM. Thus, the item of “processing” of the state transition “t₆” on line 65 in FIG. 9 is set to a value including “service vm” that means execution of processing to the VM and “state=stop” that means processing of stopping the VM.

The following describes an example of a state element that represents a modification request derived from a state element that is based on the state element type illustrated in FIG. 8 and represents a part of before state modification and a state element that is based on the state element type illustrated in FIG. 8 and represents the part of after state modification.

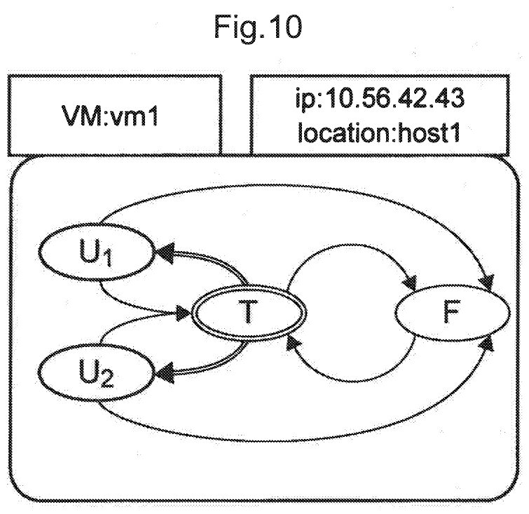

FIG. 10 is an explanatory view illustrating another example of the state element of the present example embodiment. The state element illustrated in FIG. 10 is a state element that is based on the static information of the VM included in the state element type illustrated in FIG. 8 and represents a current state of a part of before state modification. FIG. 10 represents the current state that the part takes before migration processing is executed.

FIG. 10 illustrates that the current state taken before state modification by the part “VM” that is managed by using the identifier “vm1” is the state “T”. FIG. 10 further illustrates that the ip address is set to “10.56.42.43”. FIG. 10 also illustrates that the part “VM” that is managed by using the identifier “vm1” operates in a host “host1”.

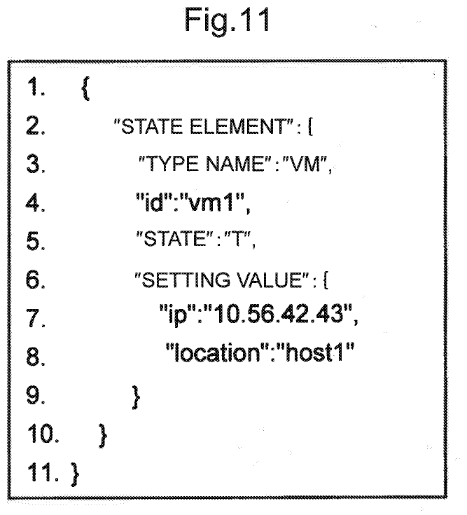

The illustrated in FIG. 11 is an example of a text-format description of the state element illustrated in FIG. 10. FIG. 11 is an explanatory view illustrating another example of the state element that is described in a text format. The text format illustrated in FIG. 11 is a JSON format.

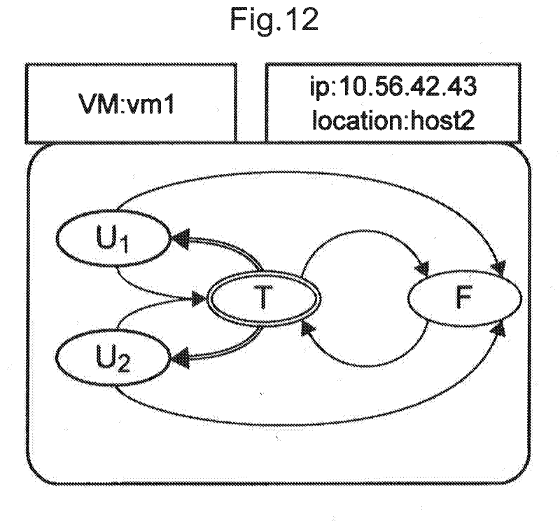

FIG. 12 is an explanatory view illustrating another example of the state element of the present example embodiment. The state element illustrated in FIG. 12 is a state element that represents a current state of a part of after state modification, is based on the static information of the VM, and is included in those of the state element type illustrated in FIG. 8. FIG. 12 represents the current state of the part after migration processing is executed.

FIG. 12 illustrates that the current state taken after state modification by the part “VM” that is managed by using the identifier “vm1” is the state “T”. FIG. 12 further illustrates that the ip address is set to “10.56.42.43”. FIG. 12 also illustrates that the part “VM” that is managed by using the identifier “vm1” operates in a host “host2”. Hosts indicated by “host1” and “host2” are, for example, physical machines.

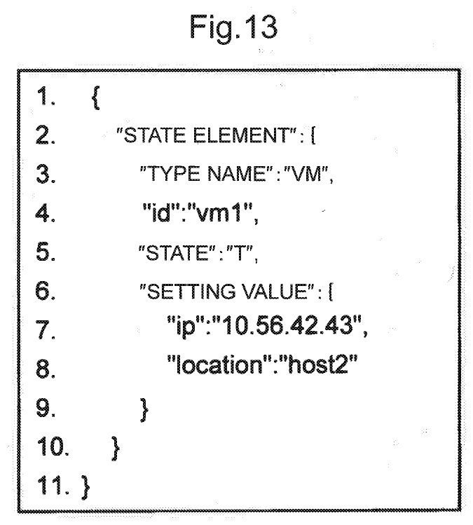

FIG. 13 illustrates an example of a text-format description of the state element illustrated in FIG. 12. FIG. 13 is an explanatory view illustrating another example of the state element that is described in a text format. The text format illustrated in FIG. 13 is a JSON format.

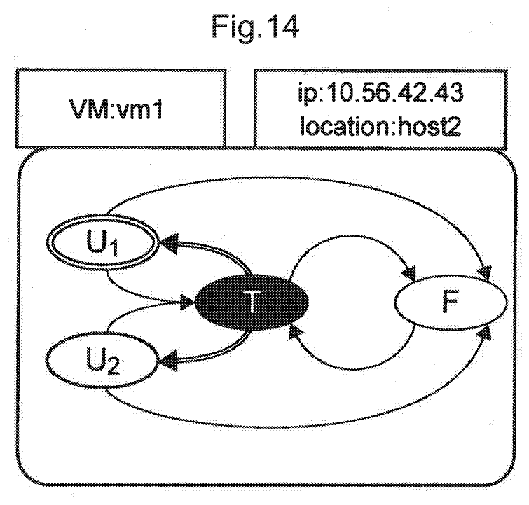

FIG. 14 illustrates a state element that represents a modification request derived from the state element illustrated in FIG. 10 and the state element illustrated in FIG. 12. FIG. 14 is an explanatory view illustrating another example of the state element of the present example embodiment. Migration processing is derived on the basis of the state element illustrated in FIG. 14.

FIG. 14 illustrates that, with regard to the part “VM” which is managed by using the identifier “vm1” and for which a modification is requested, the current state is the state “U₁” and the request state is the state “T”. FIG. 14 further illustrates that the ip address of after state modification is set to “10.56.42.43”. FIG. 14 also illustrates that the vm1 operates in a host “host2” after state modification.

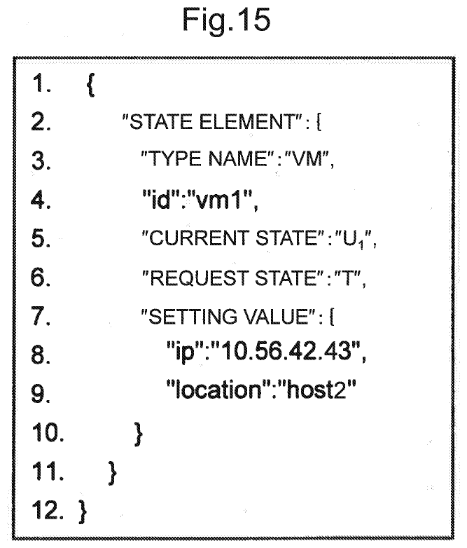

FIG. 15 illustrates an example of a text-format description of the state element illustrated in FIG. 14. FIG. 15 is an explanatory view illustrating another example of the state element that is described in a text format. The text format illustrated in FIG. 15 is a JSON format.

The state comparative calculation unit 120 of the state management system 100 generates a state element illustrated in FIG. 14 by comparing the state and setting values of the state element illustrated in FIG. 10 and the state and setting values of the state element illustrated in FIG. 12. The state comparative calculation unit 120 transfers the generated state element representing a modification request to the state element input/output unit 200.

The state element input/output unit 200 transfers, for example, the state element that represents the received modification request and the state element type that indicates the static information of the part represented by the state element to the processing execution unit (not illustrated). The processing execution unit generates a processing procedure using the transferred information and executes processing in accordance with the generated procedure.

The following describes another example of a state element representing a modification request derived from a state element that represents a part of before state modification and is based on the state element type illustrated in FIG. 8 and a state element that represents the part of after state modification and is based on the state element type illustrated in FIG. 8.

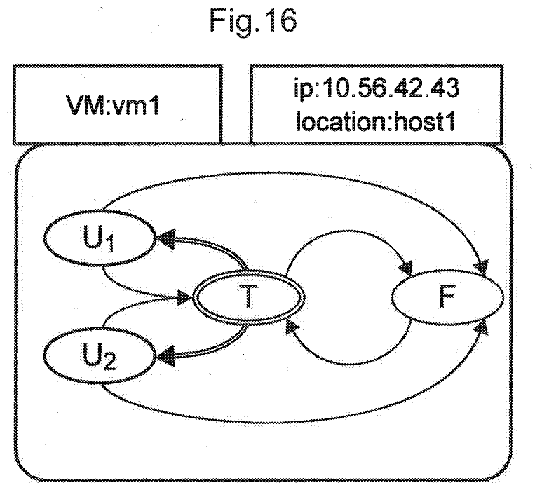

FIG. 16 is an explanatory view illustrating another example of the state element of the present example embodiment. The state element illustrated in FIG. 16 is a state element that represents a current state of a part of before state modification and is based on the static information of the VM. The static information is included in the state element type illustrated in FIG. 8. FIG. 16 represents the current state that the part takes before reload processing is executed.

FIG. 16 illustrates that, with regard to the part “VM” managed by using the identifier “vm1”, the current state of before state modification is the state “T”. FIG. 16 further illustrates that the ip address is set to “10.56.42.43”. FIG. 16 also illustrates that the part “VM” that is managed by using the identifier “vm1” operates in a host “host1”.

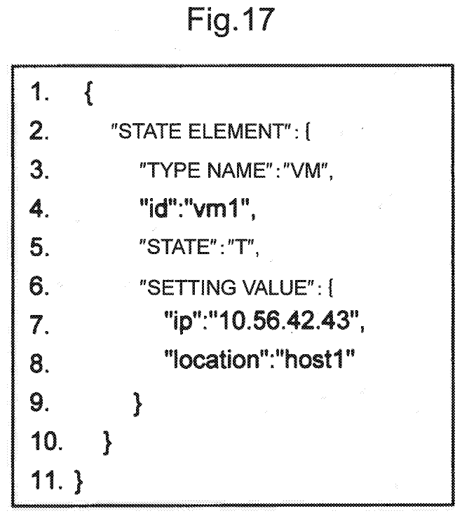

The illustrated in FIG. 17 is an example of a text-format description of the state element illustrated in FIG. 16. FIG. 17 is an explanatory view illustrating another example of the state element that is described in a text format. The text format illustrated in FIG. 17 is a JSON format.

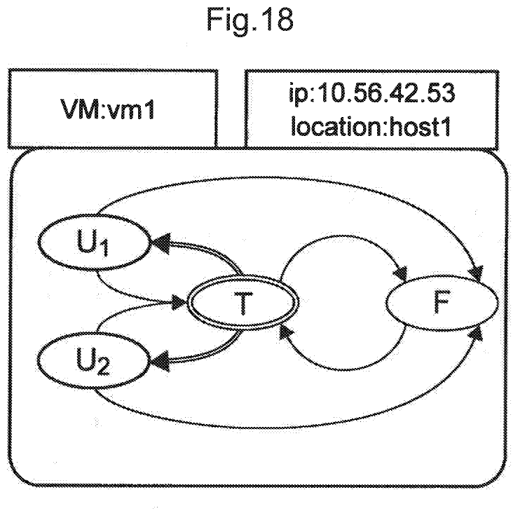

FIG. 18 is an explanatory view illustrating another example of the state element of the present example embodiment. The state element illustrated in FIG. 18 is a state element that represents a current state of the part of after state modification and is based on the static information of the VM. The static information is included in the state element type illustrated in FIG. 8. FIG. 18 represents the current state that the part takes after reload processing is executed.

FIG. 18 illustrates that, with regard to the part “VM” managed by using the identifier “vm1”, the current state of after state modification is the state “T”. FIG. 18 further illustrates that the ip address is set to “10.56.42.53”. FIG. 18 also illustrates that the part “VM” that is managed by using the identifier “vm1” operates in a host “host1”. The host indicated by “host1” is, for example, a physical machine.

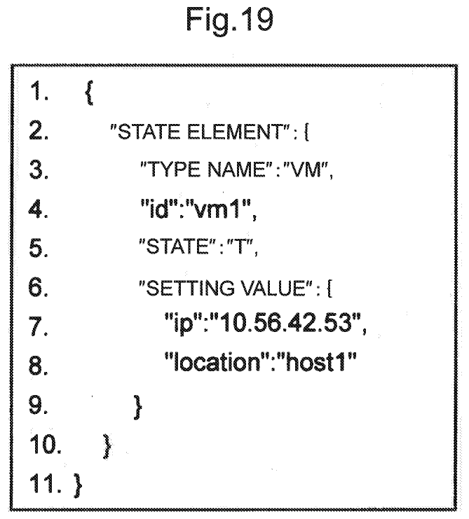

The illustrated in FIG. 19 is an example of a text-format description of the state element illustrated in FIG. 18. FIG. 19 is an explanatory view illustrating another example of the state element that is described in a text format. The text format illustrated in FIG. 19 is a JSON format.

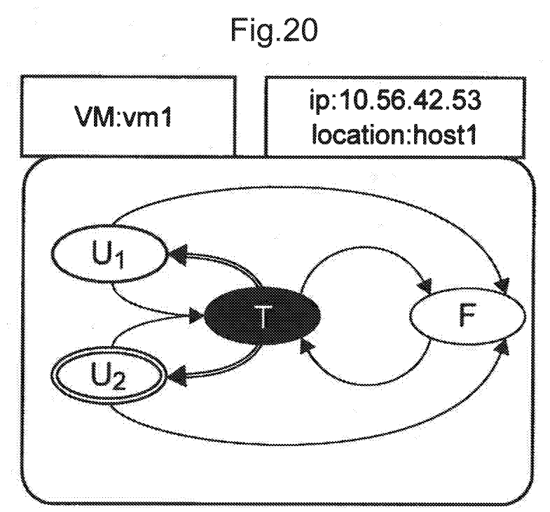

The illustrated in FIG. 20 is a state element that represents a modification request derived from the state element illustrated in FIG. 16 and the state element illustrated in FIG. 18. FIG. 20 is an explanatory view illustrating another example of the state element of the present example embodiment. Reload processing is derived on the basis of the state element illustrated in FIG. 20.

FIG. 20 illustrates that, with regard to the part “VM” that is managed by using the identifier “vm1” for which a modification is requested, the current state is the state “U₂” and the request state is the state “T”. FIG. 20 further illustrates that the ip address of after state modification is set to “10.56.42.53”. FIG. 20 also illustrates that the vm1 operates in a host “host1” after state modification.

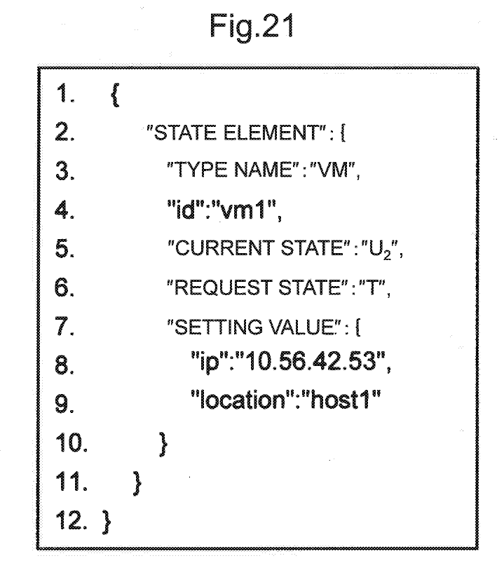

The illustrated in FIG. 21 is an example of a text-format description of the state element illustrated in FIG. 20. FIG. 21 is an explanatory view illustrating another example of the state element that is described in a text format. The text format illustrated in FIG. 21 is a JSON format.

The state comparative calculation unit 120 of the state management system 100 generates a state element illustrated in FIG. 20 by comparing the state and setting values of the state element illustrated in FIG. 16 and the state and setting values of the state element illustrated in FIG. 18. The state comparative calculation unit 120 transfers the generated state element representing the modification request to the state element input/output unit 200.

The state element input/output unit 200 transfers, for example, the received state element that represents the modification request and the state element type that indicates the static information of the part represented by the state element to the processing execution unit. The processing execution unit generates a processing procedure using the transferred information and executes the processing in accordance with the generated procedure.

The state element input/output unit 200 may generate a processing procedure using the state element that represents the modification request and the state element type that indicates the static information of the part. Alternatively, the state management system 100 may include an element equivalent to the processing execution unit.

### [Description of Operation]

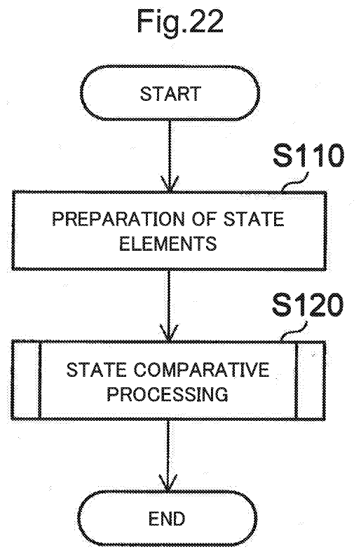

The following describes operation of generating a state element that represents a modification request by the state management system 100 of the present example embodiment with reference to FIG. 22. FIG. 22 is a flowchart illustrating the operation of the generation processing by the state management system 100 of the present example embodiment.

The state comparative calculation unit 120 receives a state element that represents a part included in a system of after state modification from the state element input/output unit 200. Next, the state comparative calculation unit 120 obtains a state element having the same identifier as the received state element and representing a part included in a system of before state modification from among state elements representing parts stored in the configuration state storing unit 110 (step S110).

Next, the state comparative calculation unit 120 performs state comparative processing in that compares the state and setting values of the state element of after state modification with the state and setting values of the state element of obtained in step S110 before state modification (step S120).

By performing the state comparative processing, the state comparative calculation unit 120 generates a state element representing a modification request that requires state modification of the part. The state comparative calculation unit 120 transfers the generated state element representing the modification request to the state element input/output unit 200. After transferring, the state management system 100 ends the generation processing.

When generating a state element, illustrated in FIG. 14, representing a modification request that requests migration processing, the state comparative calculation unit 120 receives, for example, text data that describe a state element illustrated in FIG. 13 representing the part “VM” managed by the using identifier “vm1” from the state element input/output unit 200. Next, the state comparative calculation unit 120 obtains, for example, text data that describe a state element illustrated in FIG. 11 representing the part “VM” managed by using the identifier “vm1” from the configuration state storing unit 110.

After obtaining the state element, the state comparative calculation unit 120 generates text data that describe a state element as illustrated in FIG. 15 representing a modification request that requests migration processing for the part “VM” managed by using the identifier “vm1” by comparing the two state elements. The state comparative calculation unit 120 transfers the generated text data to the state element input/output unit 200.

Similarly, when generating a state element illustrated in FIG. 20 representing a modification request that requests reload processing, the state comparative calculation unit 120 receives, for example, text data that describe the state element illustrated in FIG. 19 from the state element input/output unit 200. Next, the state comparative calculation unit 120 obtains, for example, text data that describe a state element illustrated in FIG. 17 from the configuration state storing unit 110.

After obtaining the state element, the state comparative calculation unit 120 generates text data as illustrated in FIG. 21 describing a state element representing a modification request that requests reload processing by comparing the two state elements. The state comparative calculation unit 120 transfers the generated text data to the state element input/output unit 200.

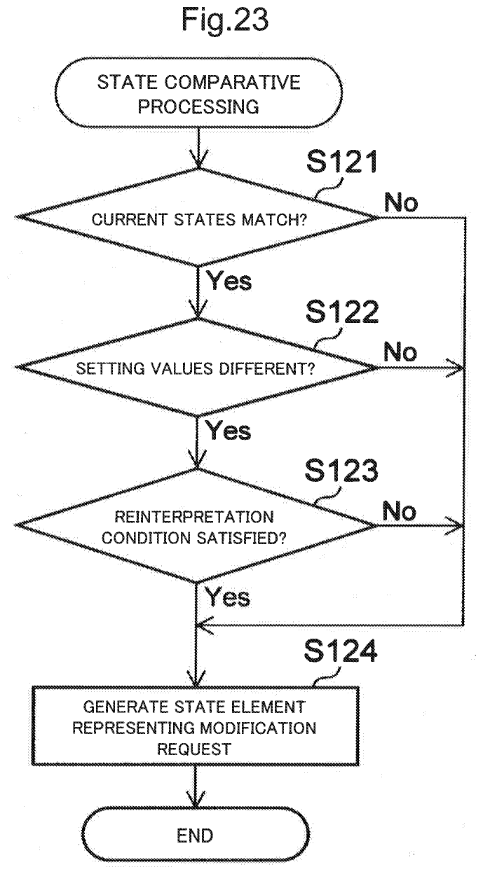

The following describes the state comparison processing of step S120 in which the state comparative calculation unit 120 redefines a current state and generates a state element that represents a modification request by comparing a state element that represents a current state of before state modification and a state element that represents a current state of after state modification. FIG. 23 is a flowchart illustrating operation of the state comparison processing by the state comparative calculation unit 120.

The state comparative calculation unit 120 compares a current state of a state element of before state modification, obtained at step S110, and a current state of a state element of after state modification, and checks whether the current states match or not (step S121).

If the current state of before state modification does not match the current state of after state modification (No at step S121), the state comparative calculation unit 120 generates a state element that represents a modification request (step S124). The state comparative calculation unit 120 sets the current state of the state element received from the state element input/output unit 200 as a request state of the state element that represents a modification request.

The state comparative calculation unit 120 also sets the current state of the state element stored in the configuration state storing unit 110 as a current state of the state element that represents a modification request. The state comparative calculation unit 120 sets the setting value of the state element received from the state element input/output unit 200 as a setting value of the state element that represents a modification request. After generating the state element that represents the modification request as described above, the state comparative calculation unit 120 ends the state comparative processing.

If the current state of before state modification and the current state of after state modification match (Yes at step S121), the state comparative calculation unit 120 compares a setting value of the state element of before state modification and a setting value of the state element of after state modification. By comparing the setting values, the state comparative calculation unit 120 determines whether the setting values are different or not (step S122).

If the setting value of the state element of before state modification and the setting value of the state element of after state modification are the same values (No at step S122), the state comparative calculation unit 120 generates a state element representing a modification request (step S124). The state comparative calculation unit 120 defines the state element that represents a modification request in which the current state is the same as the request state.

The state comparative calculation unit 120 sets the setting value of the state element received from the state element input/output unit 200 as a setting value of the state element that represents the modification request.

After generating the state element that represents the modification request as described above, the state comparative calculation unit 120 ends the state comparative processing.

When the setting value of the state element of before state modification and the setting value of the state element of after state modification are different (Yes at step S122), the state comparative calculation unit 120 determines whether a reinterpretation condition is satisfied or not (step S123).

When the reinterpretation condition is not satisfied (No at step S123), the state comparative calculation unit 120 generates a state element that represents a modification request (step S124). The state comparative calculation unit 120 redefines the current state of the state element that represents the modification request on the basis of reinterpretation information defined in the static information indicated by the state element type pertaining to the generated state element. The reinterpretation information is information that is included in the static information indicated by the state element type and is not relevant to the reinterpretation conditions.

The state comparative calculation unit 120 sets the current state of the state element received from the state element input/output unit 200 to a request state of the state element that represents the modification request. The state comparative calculation unit 120 also sets the setting value of the state element received from the state element input/output unit 200 to a setting value of the state element that represents the modification request. After generating the state element that represents the modification request as described above, the state comparative calculation unit 120 ends the state comparative processing.

When the reinterpretation condition is satisfied (Yes at step S123), the state comparative calculation unit 120 generates a state element that represents a modification request (step S124). The state comparative calculation unit 120 redefines the current state of the state element that represents the modification request on the basis of the reinterpretation information which is defined in the static information indicated by the state element type pertaining to the generated state element and is suitable for the difference of the two setting values compared at step S122.

The state comparative calculation unit 120 sets the current state of the state element received from the state element input/output unit 200 as the request state of the state element that represents the modification request.

The state comparative calculation unit 120 also sets a setting value of the state element received from the state element input/output unit 200 as the setting value of the state element that represents the modification request. After generating the state element that represents the modification request as described above, the state comparative calculation unit 120 ends the state comparative processing.

When generating a state element that represents a modification request that requests migration processing illustrated in FIG. 14, the state comparative calculation unit 120 compares, for example, text data that describe a state element of before state modification and are illustrated in FIG. 11 and text data that describe a state element of after state modification and are illustrated in FIG. 13. The “state” of the state element on line 5 in the text data illustrated in FIG. 11 and the “state” of the state element on line 5 in the text data illustrated in FIG. 13 are commonly “T” and is identical (Yes at step S121).

The setting value of “ip” on line 7 in the text data illustrated in FIG. 11 and the setting value of “ip” on line 7 in the text date illustrated in FIG. 13 are commonly “10.56.42.43”. That is, the ip address of before state modification and the ip address of after state modification are the same values.

The setting value of “location” on line 8 in the text data illustrated in FIG. 11 is “host1” and the setting value of “location” on line 8 in the text data illustrated in FIG. 13 is “host2”. That is, the host of before state modification and the host of after state modification are different (Yes at step S122).

Before the processing of step S123, the state comparative calculation unit 120 derives that the current states are commonly the state “T”, the setting values of “location” are different, and the setting values of “ip” are the same values, as a result of comparing the state element of before state modification and state element of after state modification.

As illustrated in FIG. 9, there are reinterpretation conditions on lines 15 and 24 of the text data that includes static information of the VM. The state comparative calculation unit 120 determines that the difference of the setting values derived by the above processing meets the reinterpretation condition existing on line 15 in FIG. 9 (Yes at step S123).

Accordingly, the state comparative calculation unit 120 redefines the current state of the state element representing the modification request as the state “U1” and sets the request state to the state “T” on the basis of the reinterpretation conditions illustrated in FIG. 9. The state comparative calculation unit 120 further sets the setting value of “ip” of the state element that represents a modification request to “10.56.42.43” and sets the setting value of “location” to “host2”, whereby the state comparative calculation unit 120 generates text data indicating the state element as illustrated in FIG. 15 (step S124).

Next, the processing execution unit that executes modification processing derives a processing procedure on the basis of the state element representing the modification request generated at step S124 and the state element type indicating static information, and executes the modification processing in accordance with the derived processing procedure.

Specifically, the processing execution unit that executes modification processing receives the text data illustrated in FIG. 9 and the text data illustrated in FIG. 15 and issues, for example, a command “virsh migrate vm host2” for executing the migration processing of the VM.

When generating a state element, illustrated in FIG. 20, representing a modification request to request reload processing, the state comparative calculation unit 120 executes processing of step S121 and processing of step S122 in the same way as the state comparative calculation unit 120 does when generating a state element representing a modification request to request migration processing.

The state comparative calculation unit 120 compares text data that describe a state element of before state modification and is illustrated in FIG. 17 and text data that describe a state element after state modification and is illustrated in FIG. 19. Before the processing of step S123, the state comparative calculation unit 120 derives that the current states are commonly the state “T”, the setting values of “ip” are different, and the setting values of “location” are the same values, as a result of comparing the state element of before state modification and the state element of after state modification.

Next, the state comparative calculation unit 120 generates a state element the represents a modification request on the basis of the result derived before the processing of step S123 and the reinterpretation condition indicated on line 24 of FIG. 9. Specifically, the state comparative calculation unit 120 redefines the current state of the state element representing the modification request as the state “U₂” and sets the request state to the state “T”.

The state comparative calculation unit 120 set the setting value of “ip” of the state element that represents a modification request to “10.56.42.53” and sets the setting value of “location” to “host 1”, whereby the state comparative calculation unit 120 generates text data illustrated in FIG. 21 (step S124).

Next, the processing execution unit that executes modification processing derives a processing procedure, in the same way as in the case of the modification request that requests migration processing, on the basis of the state element representing the modification request described in the text data illustrated in FIG. 21 and a state element type indicating static information, and executes modification processing according to the derived processing procedure.

Specifically, the processing execution unit that executes the modification processing receives the text data illustrated in FIG. 9 and the text data illustrated in FIG. 21 and issues, for example, a command “service networking restart” for executing reload processing that modifies and reloads the ip address of the VM.

### [Description of Effects]

The state management system 10 of the present example embodiment compares the state of a part of before state modification of the system and the state of the part of after state modification of the system and redefines the current state based on the modified setting value, and thereby derives a state element that represents a modification request. The state management system 10 of the present example embodiment is capable of determining a target state as which the current state in the state element representing a modification request is redefined on the basis of the content of modification of the setting value in the state modification.

This is because the state management system 10 of the present example embodiment can flexibly define a modification method that is represented by a state element in which a modification procedure of a state of a part included in a system is declaratively described. That is, since reinterpretation conditions are defined for each state of the state element, when referring to predefined reinterpretation conditions, the state comparative calculation unit 120 can select a target state as which a current state is redefined by using a setting value. In this way, even when there are a plurality of target states of redefining, the current state can be uniquely redefined.

The state management system 100 of the present example embodiment is achieved by, for example, a processor, such as a Central Processing Unit (CPU), that executes processing in accordance with a program stored in a storage medium. That is, the state comparative calculation unit 120 is achieved by, for example, the CPU that executes processing under the control of the program.

The configuration state storing unit 110 is achieved by a memory, such as Random Access Memory (RAM).

Each unit of the state management system 100 of the present example embodiment may be achieved by a hardware circuit.

### Second Example Embodiment

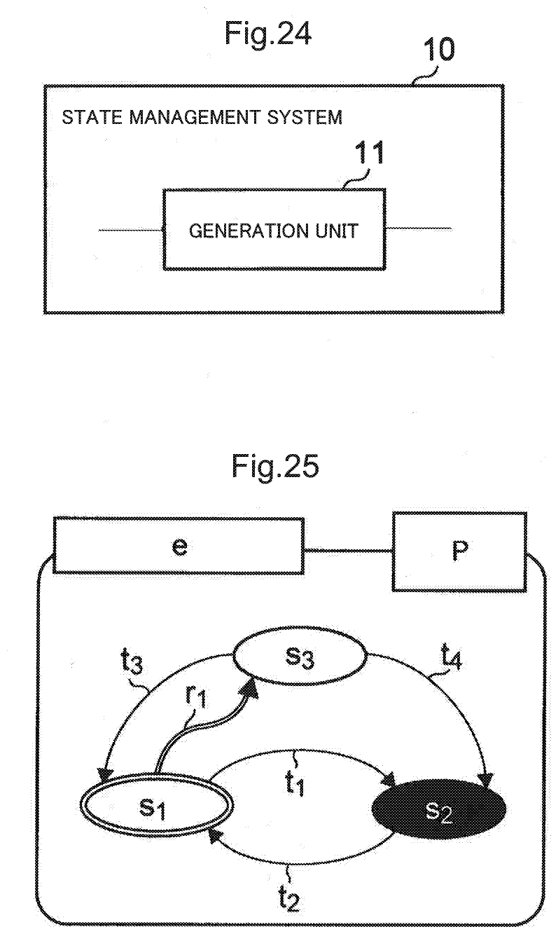

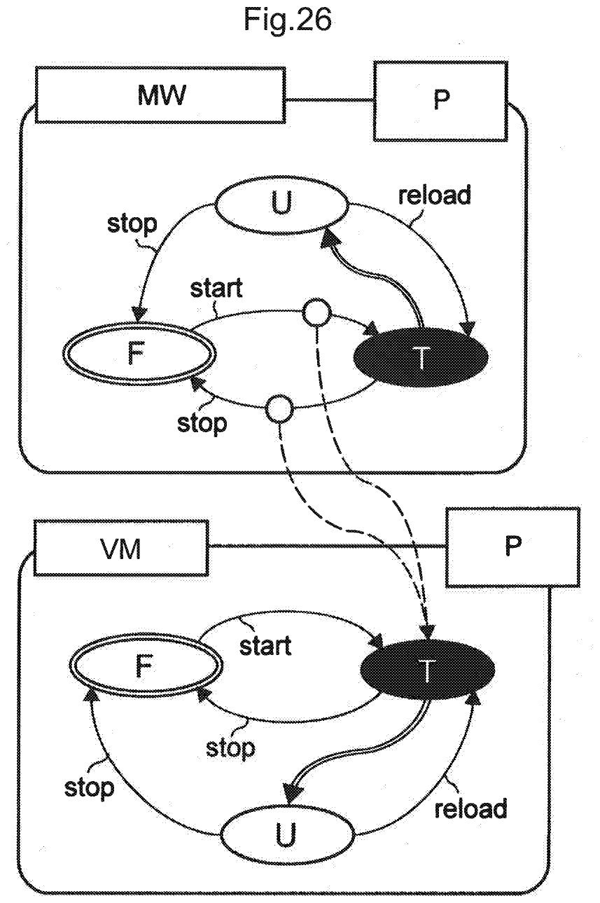

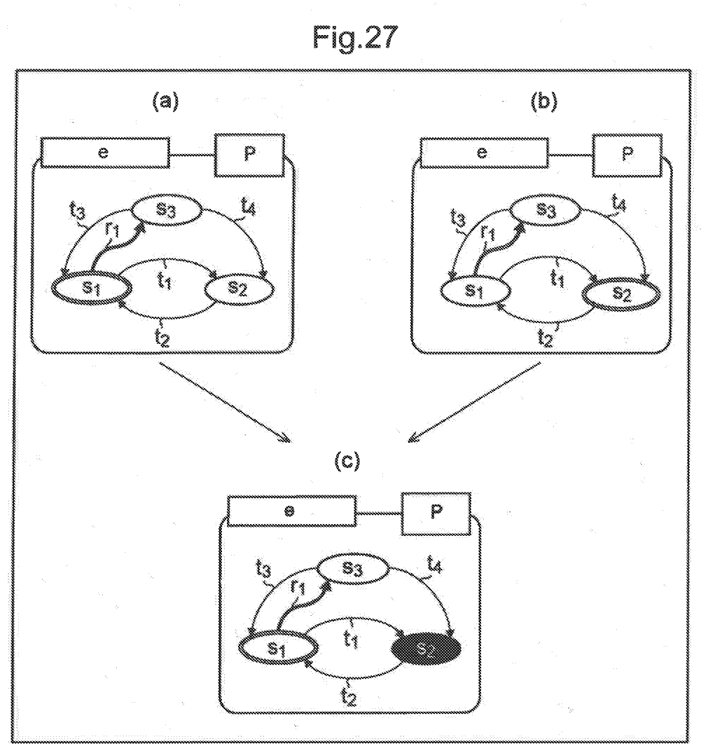

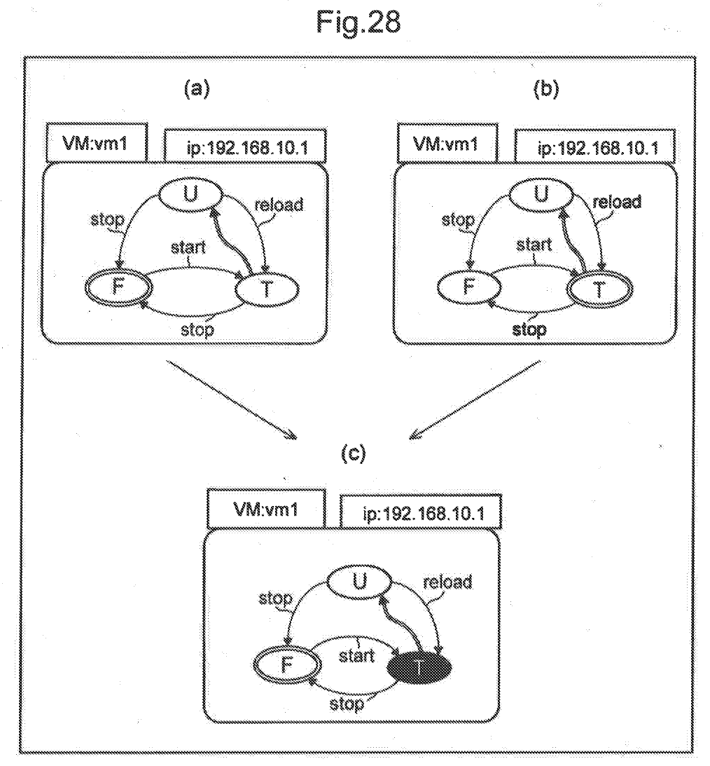

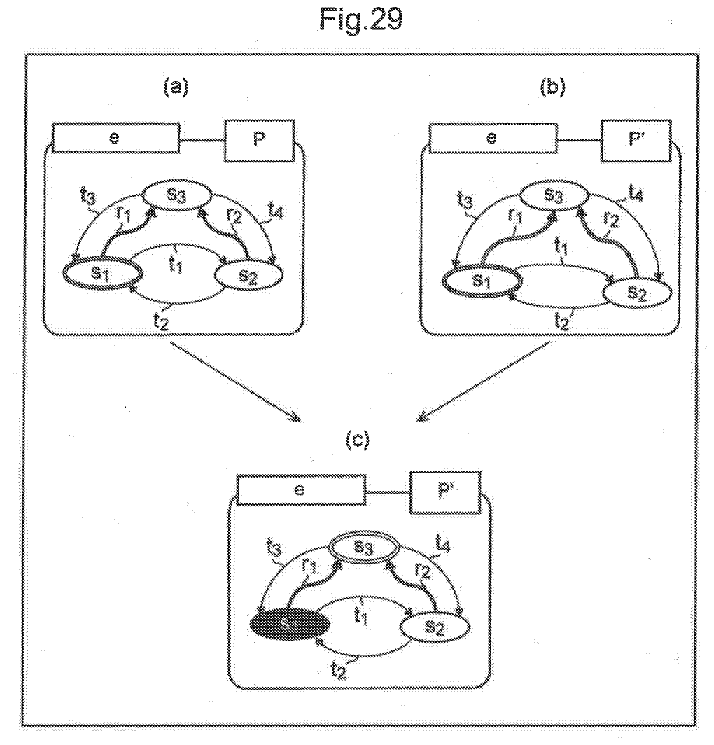

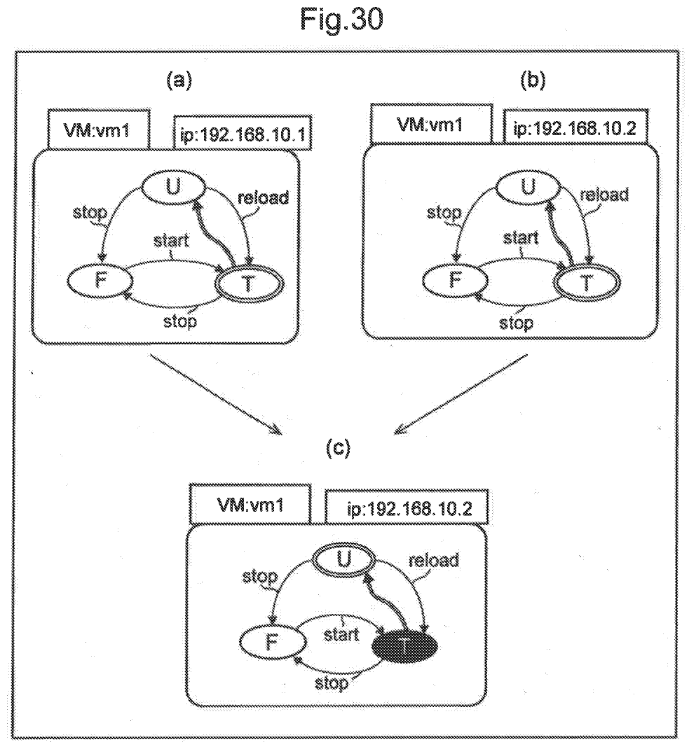

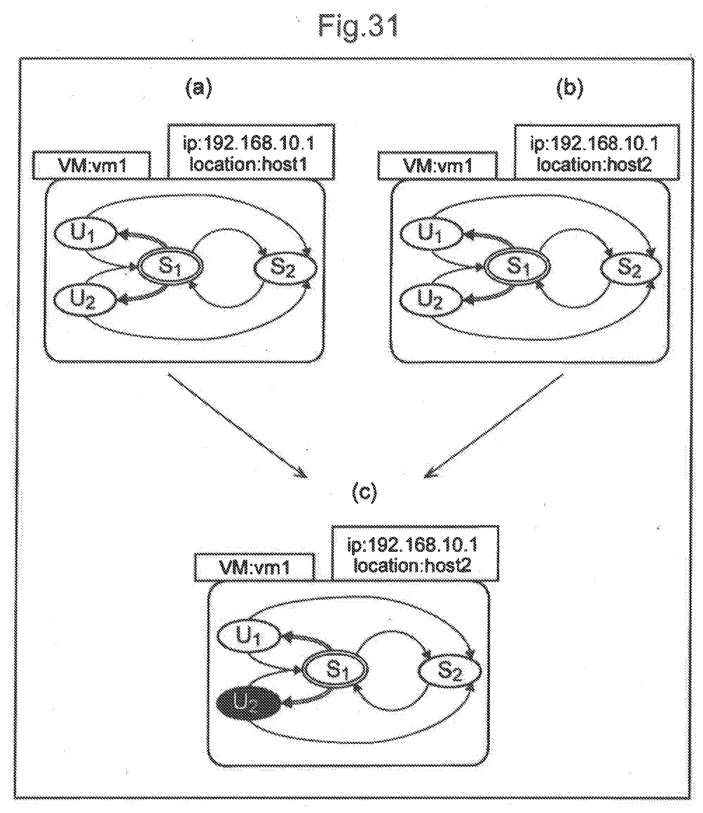

The following describes a second example embodiment of the present invention. FIG. 24 is a block view illustrating a configuration of a state management system according to the present example embodiment. The state management system 10 of the present example embodiment includes a generation unit 11. The generation unit 11 corresponds to, for example, the state comparative calculation unit 120. The generation unit 11 generates a state element that represents a modification request to change a first state element to a second state element based on the first state element and the second state element. The first state element represents a state of an element, in which a first setting value is set, in the system of before modification. The second state element represents a state of an element, in which a second setting value is set, in the system of after modification. In the present example embodiment, a current state represented by the first state element is a current state represented by the second state element. The generation unit 11 generates a state element that represents a modification request in which the current state is a request state, a state that depends on difference of the first setting value and the second setting value is the current state, and the second setting value is a setting value of after modification.

With such a configuration, the state management system 10 is capable of determining a target state as which the current state in a state element representing a modification request is redefined.

The state management system 10 may further include a storage unit (for example, the configuration state storing unit 110) that stores a state element type that indicates static information pertaining to a state element. The storage unit corresponds to, for example, the configuration state storing unit 110. The generation unit 11 may extract a state element type pertaining to the first state element and the second state element from the storage unit and may generate a state element that represents a modification request based on a correspondence relation of a state and the difference between the first setting value and the second setting value which are indicated by the extracted state element type.

With such a configuration, the state management system 10 is capable of determining a target state as which the current state in a state element representing a modification request is redefined by using reinterpretation conditions defined in a state element type.

The storage unit may further store state elements. The generation unit 11 may extract a first state element related with to an input second state element from the storage means and may generate a state element that represents a modification request based on the extracted first state element and the second state element.

With such a configuration, the state management system 10 is capable of generating a state element that represents a modification request based on a state element that is input by a user and represents a state of a part included in a system of after modification.

The generation unit 11 may input the state element that represents the generated modification request into a procedure generation unit that generates a modification procedure.

With such a configuration, the state management system 10 is capable of generating a modification procedure from the state element that represents the generated modification request.

A state indicated by a state element may be defined by a discrete value, and a setting value indicated by the state element may be defined by a plurality of continuous values.

### Other Example Embodiments

As described above, each of the state management systems according to the example embodiments of the present invention can be achieved by a computer that includes a memory into which a program is loaded and a processor that executes the program loaded in the memory. Each of the state management systems according to the example embodiments of the present invention can be achieved by dedicated hardware, such as a circuit. The state management system according to the example embodiments of the present invention can be achieved by a combination of the above-described computer and dedicated hardware.

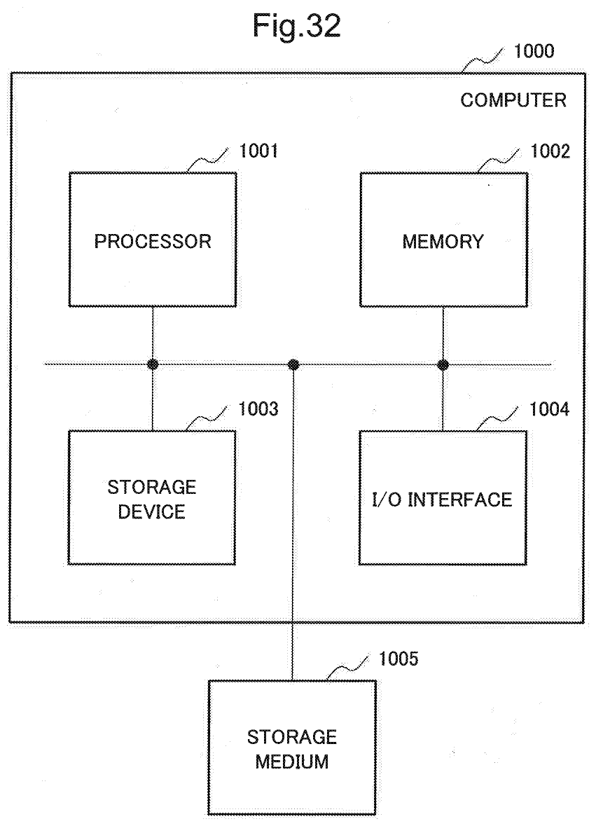

FIG. 32 is a block view representing a hardware configuration of a computer that is capable of achieving the state management systems (e.g. the state management system 100 and the state management system 10) according to the example embodiments of the present invention. As illustrated in FIG. 32, the computer 1000 includes a processor 1001, a memory 1002, a storage device 1003, and an I/O (Input/Output) interface 1004. The computer 1000 can access a storage medium 1005. The memory 1002 and the storage device 1003 may be storage devices, such as a Random Access Memory (RAM) and a hard disk. The storage medium 1005 is, for example, a storage device, such as a RAM or a hard disk, a Read Only Memory (ROM), or a portable storage medium. The storage device 1003 may be the storage medium 1005. The processor 1001 can read and write data and a program from and into the memory 1002 and the storage device 1003. The processor 1001 can access, for example, the state element input/output unit 200 through the I/O interface 1004. The processor 1001 can access the storage medium 1005.

The storage medium 1005 may store a program that causes the computer 1000 to operate, for example, as the state management system 100. In other words, the storage medium 1005 may store a program that achieves the functions of the configuration state storing unit 110 and the state comparative calculation unit 120. The processor 1001 loads the program stored in the storage medium 1005 into the memory 1002. The processor 1001 executes the program loaded in the memory 1002. Then, the computer 1000 operates as the state management system 100. That is, the configuration state storing unit 110 and the state comparative calculation unit 120 can be achieved by the memory 1002 into which the above-described program is loaded and the processor 1001 that executes the program. Each of the configuration state storing unit 110 and the state comparative calculation unit 120 can be achieved by a dedicated circuit.

The configuration state storing unit 110 and state comparative calculation unit 120 can be achieved by a combination of the above-described processor 1001, memory 1002, and a dedicated circuit.

The storage medium 1005 may store a program that causes the computer 1000 to operate, for example, as the state management system 10. In other words, the storage medium 1005 may store, for example, a program that achieves the function of the generation unit 11. The processor 1001 loads the program stored in the storage medium 1005 into the memory 1002. The processor 1001 executes the program loaded in the memory 1002. Then, the computer 1000 operates as the state management system 10. That is, the generation unit 11 can be achieved by the memory 1002 into which the above-described program is loaded and the processor 1001 that executes the program. The generation unit 11 can instead be achieved by a dedicated circuit. The generation unit 11 can be achieved by a combination of the above-described processor 1001, memory 1002, and a dedicated circuit.

The claimed invention has been described so far with reference to the above-described embodiments, without limitation thereto. A variety of modifications that will be understood by those skilled in the art can be made to the configuration and details of the claimed invention within the scope thereof.

This application claims priority based on Japanese Patent Application No. 2016-040767 filed on Mar. 3, 2016, the disclosure of which is incorporated herein in its entirety by its reference.

### REFERENCE SIGNS LIST

11 Generation unit
10, 100 State management system
110 Configuration state storing unit
120 State comparative calculation unit
200 State element input/output unit
1000 Computer
1001 Processor
1002 Memory
1003 Storage device
1004 I/O interface
1005 Storage medium

What is claimed is:

1. A state management system comprising:
a memory that stores a set of instructions; and
at least one processor configured to execute the set of instructions to:
generate a state element that represents a modification request to change a first state element to a second state element based on the first state element and the second state element, the first state element representing a state of an element, in which a first setting value is set, of a system of before modification, the second state element representing a state of the element, in which a second setting value is set, of the system of after modification, wherein
a current state indicated by the first state element is a current state indicated by the second state element, and
the at least one processor generates the state element representing the modification request indicating that the current state is a request state, a state that depends on difference between the first setting value and the second setting value is the current state, and the second setting value is a setting value after modification.

2. The state management system according to claim 1, wherein
the memory stores a state element type indicating static information pertaining to the state element, and
at least one processor is further configured to:
extract the state element type pertaining to the first state element and the second state element from among stored state element types each of which indicates static information pertaining to a state element; and
generate the state element that represents the modification request based on a correspondence relation of difference and states between the first setting value and the second setting value indicated by the extracted state element type.

3. The state management system according to claim 2, wherein
the memory stores the state elements,
the at least one processor is further configured to:
extract, from among stored state elements, the first state element relating to the second state element that is input; and
generate the state element that represents the modification request based on the extracted first state element and the second state element.

4. The state management system according to claim 1, wherein
the at least one processor is further configured to
generate a modification procedure based on the generated state element that represents the modification request.

5. A state management method comprising:
generating a state element that represents a modification request to change a first state element to a second state element based on the first state element and the second element, the first element representing a state of an element, in which a first setting value is set, of a system of before modification, the second state element representing a state of the element, in which a second setting value is set, of the system of after modification, wherein,
a current state indicated by the first state element is a current state indicated by the second state element, and
the generating the state element includes generating the state element representing the modification request indicating that the current state is a request state, a state that depends on difference between the first setting value and the second setting value is the current state, and the second setting value is a setting value after modification.

6. The state management method according to claim 5, further comprising:
extracting the state element type pertaining to the first state element and the second state element from among stored state element types each of which indicates static information pertaining to a state element; and
generating the state element that represents the modification request based on a correspondence relation of difference and states between the first setting value and the second setting value indicated by the extracted state element type.

7. The state management method according to claim 5, further comprising:
extracting, from among stored state elements, the first state element relating to the second state element that is input; and
generating the state element that represents the modification request, based on the extracted first state element and the second state element.

8. A non-transitory computer readable storage medium storing a state management program causing a computer to execute:
generation processing of generating a state element that represents a modification request to change a first state element to a second state element based on the first state element and the second state element, the first state element representing a state of an element, in which a first setting value is set, of a system of before modification, the second state element representing a state of the element, in which a second setting value is set, of the system after modification, wherein
a current state indicated by the first state element is a current state indicated by the second state element, and
the generation processing generates the state element representing the modification request indicating that the current state is a request state, a state that depends on difference between the first setting value and the second setting value is the current state, and the second setting value is a setting value after modification.

9. The storage medium according to claim 8, storing the state management program, wherein
the generation processing extracts the state element type pertaining to the first state element and the second state element from among stored state element types each of which indicates static information pertaining to a state element, and generates the state element that represents the modification request, based on a correspondence relation of difference and states between the first setting value and the second setting value indicated by the extracted state element type.

10. The storage medium according to claim 8, storing the state management program, wherein
the generation processing extracts, from among stored state elements, the first state element relating to the second state element that is input, and generates the state element that represents the modification request, based on the extracted first state element and the second state element.
